(19) United States
(12) Patent Application Publication
(10) Pub. No.: US 2013/0010716 A1
(43) Pub. Date: Jan. 10, 2013

(54) Carrier Configuration in Multicarrier Systems

(76) Inventor: Esmael Dinan, Herndon, VA (US)

(21) Appl. No.: 13/540,654

(22) Filed: Jul. 3, 2012

Related U.S. Application Data
(60) Provisional application No. 61/506,120, filed on Jul. 10, 2011.
(60) Provisional application No. 61/528,226, filed on Aug. 27, 2011.

(51) Int. Cl. H04W 72/04

(52) U.S. Cl. 370/329

(57) ABSTRACT

A base station transmits data packets to a wireless device using carrier aggregation. A first downlink carrier carries the broadcast control information for the wireless device. The base station receives a physical uplink control channel on a first uplink carrier. The base station transmits at least one control message to the wireless device reconfiguring the carriers of the wireless device. A second downlink carrier carries the broadcast control information for the wireless device and a second uplink carrier carries the physical uplink control channel.

### CROSS-REFERENCE TO RELATED APPLICATIONS

This application claims the benefit of U.S. Provisional Application No. 61/506,120, filed Jul. 10, 2011, entitled “Connection Reconfiguration in a Multicarrier OFDM Network,” and U.S. Provisional Application No. 61/528,226, filed Aug. 27, 2011, entitled “Carrier Configuration in Multicarrier Systems,” which are hereby incorporated by reference in its entirety.

### BRIEF DESCRIPTION OF THE SEVERAL VIEWS OF THE DRAWINGS

Examples of several of the various embodiments of the present invention are described herein with reference to the drawings, in which:

FIG. 1 is a diagram depicting example sets of OFDM subcarriers as per an aspect of an embodiment of the present invention;

FIG. 2 is a diagram depicting an example transmission time and reception time for two carriers as per an aspect of an embodiment of the present invention;

FIG. 3 is a diagram depicting OFDM radio resources as per an aspect of an embodiment of the present invention;

FIG. 4 is a block diagram of a base station and a wireless device as per an aspect of an embodiment of the present invention;

FIG. 5 is a block diagram depicting a system for transmitting data traffic over an OFDM radio system as per an aspect of an embodiment of the present invention;

FIG. 6 is a diagram illustrating the measurement results for at least one secondary carrier as per an aspect of an embodiment of the present invention;

FIG. 7 is diagram depicting an example changes in carrier configuration after RRC reconfiguration message is processed as per an aspect of an embodiment of the present invention; and

FIG. 8 is an example flow chart for carrier reconfiguration as per an aspect of an embodiment of the present invention.

### DETAILED DESCRIPTION OF EMBODIMENTS

Example embodiments of the present invention reconfigure a connection in a multicarrier OFDM communication system. Embodiments of the technology disclosed herein may be employed in the technical field of multicarrier communication systems. More particularly, the embodiments of the technology disclosed herein may relate to connection reconfiguration in a multicarrier OFDM communication system.

Example embodiments of the invention may be implemented using various physical layer modulation and transmission mechanisms. Example transmission mechanisms may include, but are not limited to: CDMA (code division multiple access), OFDM (orthogonal frequency division multiplexing), TDMA (time division multiple access), Wavelet technologies, and/or the like. Hybrid transmission mechanisms such as TDMA/CDMA, and OFDM/CDMA may also be employed. Various modulation schemes may be applied for signal transmission in the physical layer. Examples of modulation schemes include, but are not limited to: phase, amplitude, code, a combination of these, and/or the like. An example radio transmission method may implement QAM (quadrature amplitude modulation) using BPSK (binary phase shift keying), QPSK (quadrature phase shift keying), 16-QAM, 64-QAM, 256-QAM, and/or the like. Physical radio transmission may be enhanced by dynamically or semi-dynamically changing the modulation and coding scheme depending on transmission requirements and radio conditions.

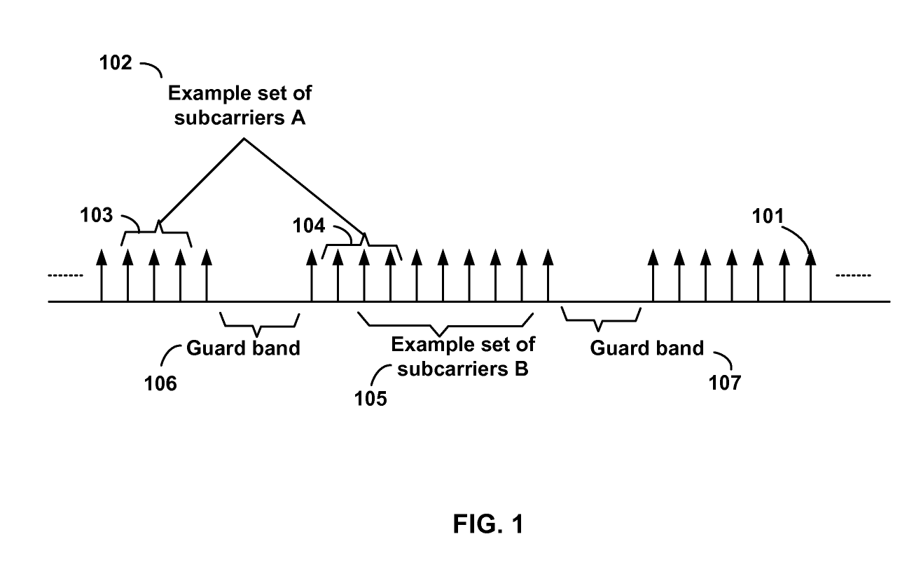

FIG. 1 is a diagram depicting example sets of OFDM subcarriers as per an aspect of an embodiment of the present invention. As illustrated in this example, arrow(s) in the diagram may depict a subcarrier in a multicarrier OFDM system. The OFDM system may use technology such as OFDM technology, SC-OFDM (single carrier-OFDM) technology, or the like. For example, arrow 101 shows a subcarrier transmitting information symbols. FIG. 1 is for illustration purposes, and a typical multicarrier OFDM system may include more subcarriers in a carrier. For example, the number of subcarriers in a carrier may be in the range of 10 to 10,000 subcarriers.

FIG. 1 shows two guard bands 106 and 107 in a transmission band. As illustrated in FIG. 1, guard band 106 is between subcarriers 103 and subcarriers 104. The example set of subcarriers A 102 includes subcarriers 103 and subcarriers 104. FIG. 1 also illustrates an example set of subcarriers B 105. As illustrated, there is no guard band between any two subcarriers in the example set of subcarriers B 105. Carriers in a multicarrier OFDM communication system may be contiguous carriers, non-contiguous carriers, or a combination of both contiguous and non-contiguous carriers.

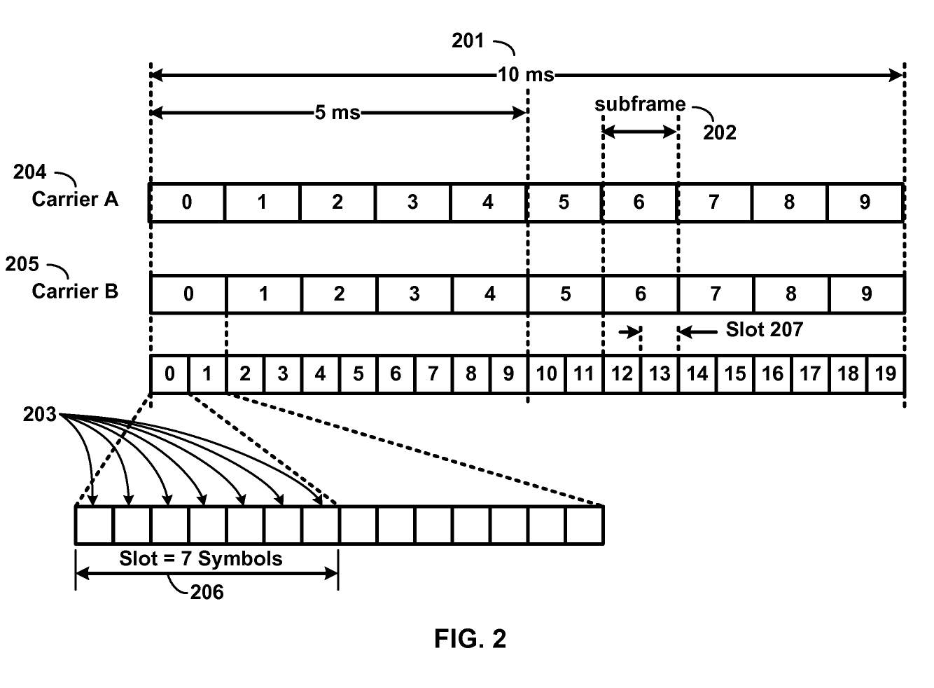

FIG. 2 is a diagram depicting an example transmission time and reception time for two carriers as per an aspect of an embodiment of the present invention. A multicarrier OFDM communication system may include one or more carriers, for example, ranging from 1 to 10 carriers. Carrier A 204 and carrier B 205 may have the same or different timing structures. Although FIG. 2 shows two synchronized carriers, carrier A 204 and carrier B 205 may or may not be synchronized with each other. Different radio frame structures may be supported for FDD (frequency division duplex) and TDD (time division duplex) duplex mechanisms. FIG. 2 shows an example FDD frame timing. Downlink and uplink transmissions may be organized into radio frames 201. In this example, radio frame duration is 10 msec. Other frame durations, for example, in the range of 1 to 100 msec may also be supported. In this example, each 10 ms radio frame 201 may be divided into ten equally sized sub-frames 202. Other subframe durations such as including 0.5 msec, 1 msec, 2 msec, and 5 msec may also be supported. Sub-frame(s) may consist of two or more slots 206. For the example of FDD, 10 subframes may be available for downlink transmission and 10 subframes may be available for uplink transmissions in each 10 ms interval. Uplink and downlink transmissions may be separated in the frequency domain. Slot(s) may include a plurality of OFDM symbols 203. The number of OFDM symbols 203 in a slot 206 may depend on the cyclic prefix length and subcarrier spacing.

In an example case of TDD, uplink and downlink transmissions may be separated in the time domain. According to some of the various aspects of embodiments, each 10 ms radio frame may include two half-frames of 5 ms each. Half-frame(s) may include eight slots of length 0.5 ms and three special fields: DwPTS (Downlink Pilot Time Slot), GP (Guard Period) and UpPTS (Uplink Pilot Time Slot). The length of DwPTS and UpPTS may be configurable subject to the total length of DwPTS, GP and UpPTS being equal to 1 ms. Both 5 ms and 10 ms switch-point periodicity may be supported. In an example, subframe 1 in all configurations and subframe 6 in configurations with 5 ms switch-point periodicity may include DwPTS, GP and UpPTS. Subframe 6 in configurations with 10 ms switch-point periodicity may include DwPTS. Other subframes may include two equally sized slots. For this TDD example, GP may be employed for downlink to uplink transition. Other subframes/fields may be assigned for either downlink or uplink transmission. Other frame structures in addition to the above two frame structures may also be supported, for example in one example embodiment the frame duration may be selected dynamically based on the packet sizes.

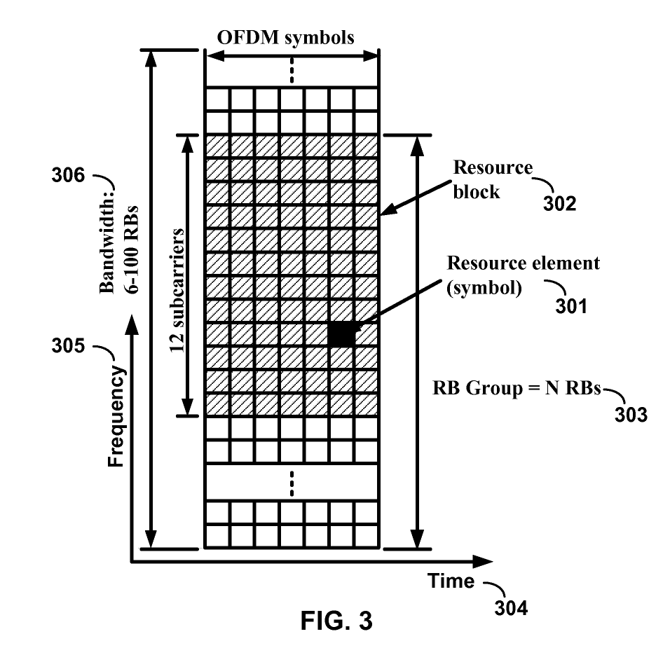

FIG. 3 is a diagram depicting OFDM radio resources as per an aspect of an embodiment of the present invention. The resource grid structure in time 304 and frequency 305 is illustrated in FIG. 3. The quantity of downlink subcarriers or resource blocks (RB) (in this example 6 to 100 RBs) may depend, at least in part, on the downlink transmission bandwidth 306 configured in the cell. The smallest radio resource unit may be called a resource element (e.g. 301). Resource elements may be grouped into resource blocks (e.g. 302). Resource blocks may be grouped into larger radio resources called Resource Block Groups (RBG) (e.g. 303). The transmitted signal in slot 206 may be described by one or several resource grids of a plurality of subcarriers and a plurality of OFDM symbols. Resource blocks may be used to describe the mapping of certain physical channels to resource elements. Other pre-defined groupings of physical resource elements may be implemented in the system depending on the radio technology. For example, 24 subcarriers may be grouped as a radio block for a duration of 5 msec.

Physical and virtual resource blocks may be defined. A physical resource block may be defined as N consecutive OFDM symbols in the time domain and M consecutive subcarriers in the frequency domain, wherein M and N are integers. A physical resource block may include M×N resource elements. In an illustrative example, a resource block may correspond to one slot in the time domain and 180 kHz in the frequency domain (for 15 KHz subcarrier bandwidth and 12 subcarriers). A virtual resource block may be of the same size as a physical resource block. Various types of virtual resource blocks may be defined (e.g. virtual resource blocks of localized type and virtual resource blocks of distributed type). For various types of virtual resource blocks, a pair of virtual resource blocks over two slots in a subframe may be assigned together by a single virtual resource block number. Virtual resource blocks of localized type may be mapped directly to physical resource blocks such that sequential virtual resource block k corresponds to physical resource block k. Alternatively, virtual resource blocks of distributed type may be mapped to physical resource blocks according to a predefined table or a predefined formula. Various configurations for radio resources may be supported under an OFDM framework, for example, a resource block may be defined as including the subcarriers in the entire band for an allocated time duration.

According to some of the various aspects of embodiments, an antenna port may be defined such that the channel over which a symbol on the antenna port is conveyed may be inferred from the channel over which another symbol on the same antenna port is conveyed. In some embodiments, there may be one resource grid per antenna port. The set of antenna port(s) supported may depend on the reference signal configuration in the cell. Cell-specific reference signals may support a configuration of one, two, or four antenna port(s) and may be transmitted on antenna port(s) {0}, {0, 1}, and {0, 1, 2, 3}, respectively. Multicast-broadcast reference signals may be transmitted on antenna port 4. Wireless device-specific reference signals may be transmitted on antenna port(s) 5, 7, 8, or one or several of ports {7, 8, 9, 10, 11, 12, 13, 14}. Positioning reference signals may be transmitted on antenna port 6. Channel state information (CSI) reference signals may support a configuration of one, two, four or eight antenna port(s) and may be transmitted on antenna port(s) 15, {15, 16}, {15, . . . , 18} and {15, . . . , 22}, respectively. Various configurations for antenna configuration may be supported depending on the number of antennas and the capability of the wireless devices and wireless base stations.

According to some embodiments, a radio resource framework using OFDM technology may be employed. Alternative embodiments may be implemented employing other radio technologies. Example transmission mechanisms include, but are not limited to: CDMA, OFDM, TDMA, Wavelet technologies, and/or the like. Hybrid transmission mechanisms such as TDMA/CDMA, and OFDM/CDMA may also be employed.

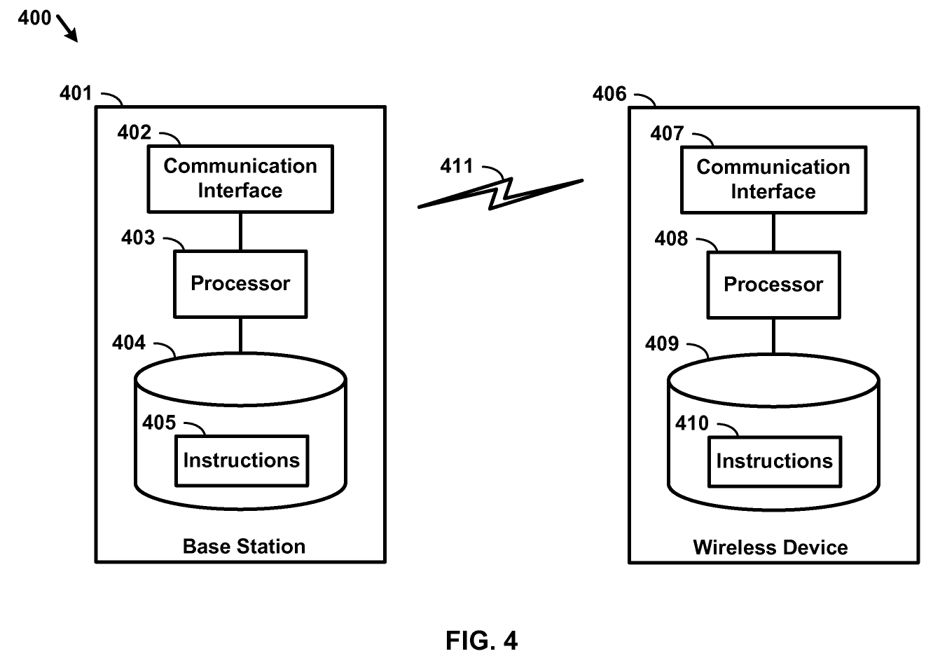

FIG. 4 is an example block diagram of a base station 401 and a wireless device 406, as per an aspect of an embodiment of the present invention. A communication network 400 may include at least one base station 401 and at least one wireless device 406. The base station 401 may include at least one communication interface 402, at least one processor 403, and at least one set of program code instructions 405 stored in non-transitory memory 404 and executable by the at least one processor 403. The wireless device 406 may include at least one communication interface 407, at least one processor 408, and at least one set of program code instructions 410 stored in non-transitory memory 409 and executable by the at least one processor 408. Communication interface 402 in base station 401 may be configured to engage in communication with communication interface 407 in wireless device 406 via a communication path that includes at least one wireless link 411. Wireless link 411 may be a bi-directional link. Communication interface 407 in wireless device 406 may also be configured to engage in a communication with communication interface 402 in base station 401. Base station 401 and wireless device 406 may be configured to send and receive data over wireless link 411 using multiple frequency carriers. According to some of the various aspects of embodiments, transceiver(s) may be employed. A transceiver is a device that includes both a transmitter and receiver. Transceivers may be employed in devices such as wireless devices, base stations, relay nodes, and/or the like. Example embodiments for radio technology implemented in communication interface 402, 407 and wireless link 411 are illustrated are FIG. 1, FIG. 2, and FIG. 3. and associated text.

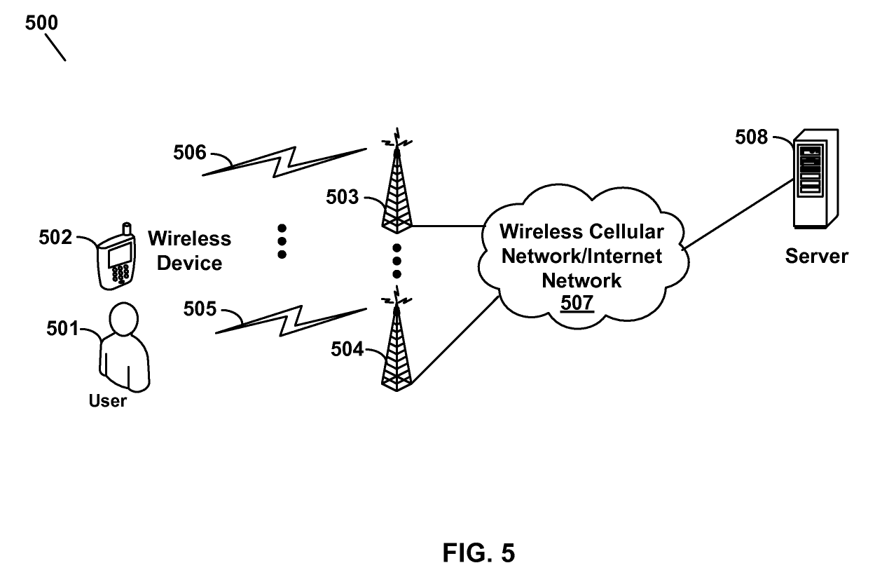

FIG. 5 is a block diagram depicting a system 500 for transmitting data traffic generated by a wireless device 502 to a server 508 over a multicarrier OFDM radio according to one aspect of the illustrative embodiments. The system 500 may include a Wireless Cellular Network/Internet Network 507, which may function to provide connectivity between one or more wireless devices 502 (e.g., a cell phone, PDA (personal digital assistant), other wirelessly-equipped device, and/or the like), one or more servers 508 (e.g. multimedia server, application servers, email servers, or database servers) and/or the like.

It should be understood, however, that this and other arrangements described herein are set forth for purposes of example only. As such, those skilled in the art will appreciate that other arrangements and other elements (e.g., machines, interfaces, functions, orders of functions, etc.) may be used instead, some elements may be added, and some elements may be omitted altogether. Further, as in most telecommunications applications, those skilled in the art will appreciate that many of the elements described herein are functional entities that may be implemented as discrete or distributed components or in conjunction with other components, and in any suitable combination and location. Still further, various functions described herein as being performed by one or more entities may be carried out by hardware, firmware and/or software logic in combination with hardware. For instance, various functions may be carried out by a processor executing a set of machine language instructions stored in memory.

As shown, the access network may include a plurality of base stations 503 . . . 504. Base station 503 . . . 504 of the access network may function to transmit and receive RF (radio frequency) radiation 505 . . . 506 at one or more carrier frequencies, and the RF radiation may provide one or more air interfaces over which the wireless device 502 may communicate with the base stations 503 . . . 504. The user 501 may use the wireless device (or UE: user equipment) to receive data traffic, such as one or more multimedia files, data files, pictures, video files, or voice mails, etc. The wireless device 502 may include applications such as web email, email applications, upload and ftp applications, MMS (multimedia messaging system) applications, or file sharing applications. In another example embodiment, the wireless device 502 may automatically send traffic to a server 508 without direct involvement of a user. For example, consider a wireless camera with automatic upload feature, or a video camera uploading videos to the remote server 508, or a personal computer equipped with an application transmitting traffic to a remote server.

One or more base stations 503 . . . 504 may define a corresponding wireless coverage area. The RF radiation 505 . . . 506 of the base stations 503 . . . 504 may carry communications between the Wireless Cellular Network/Internet Network 507 and access device 502 according to any of a variety of protocols. For example, RF radiation 505 . . . 506 may carry communications according to WiMAX (Worldwide Interoperability for Microwave Access e.g., IEEE 802.16), LTE (long term evolution), microwave, satellite, MMDS (Multichannel Multipoint Distribution Service), Wi-Fi (e.g., IEEE 802.11), Bluetooth, infrared, and other protocols now known or later developed. The communication between the wireless device 502 and the server 508 may be enabled by any networking and transport technology for example TCP/IP (transport control protocol/Internet protocol), RTP (real time protocol), RTCP (real time control protocol), HTTP (Hypertext Transfer Protocol) or any other networking protocol.

According to some of the various aspects of embodiments, an LTE network may include many base stations, providing a user plane (PDCP: packet data convergence protocol/RLC: radio link control/MAC: media access control/PHY: physical) and control plane (RRC: radio resource control) protocol terminations towards the wireless device. The base station(s) may be interconnected with other base station(s) by means of an X2 interface. The base stations may also be connected by means of an S1 interface to an EPC (Evolved Packet Core). For example, the base stations may be interconnected to the MME (Mobility Management Entity) by means of the S1-MME interface and to the Serving Gateway (S-GW) by means of the S1-U interface. The S1 interface may support a many-to-many relation between MMEs/Serving Gateways and base stations. A base station may include many sectors for example: 1, 2, 3, 4, or 6 sectors. A base station may include many cells, for example, ranging from 1 to 50 cells or more. A cell may be categorized, for example, as a primary cell or secondary cell. When carrier aggregation is configured, a wireless device may have one RRC connection with the network. At RRC connection establishment/re-establishment/handover, one serving cell may provide the NAS (non-access stratum) mobility information (e.g. TAI-tracking area identifier), and at RRC connection re-establishment/handover, one serving cell may provide the security input. This cell may be referred to as the Primary Cell (PCell). In the downlink, the carrier corresponding to the PCell may be the Downlink Primary Component Carrier (DL PCC), while in the uplink, it may be the Uplink Primary Component Carrier (UL PCC). Depending on wireless device capabilities, Secondary Cells (SCells) may be configured to form together with the PCell a set of serving cells. In the downlink, the carrier corresponding to an SCell may be a Downlink Secondary Component Carrier (DL SCC), while in the uplink, it may be an Uplink Secondary Component Carrier (UL SCC). An SCell may or may not have an uplink carrier.

A cell, comprising a downlink carrier and optionally an uplink carrier, is assigned a physical cell ID and a cell index. A carrier (downlink or uplink) belongs to only one cell, the cell ID or Cell index may also identify the downlink carrier or uplink carrier of the cell (depending on the context it is used). In the specification, cell ID may be equally referred to a carrier ID, and cell index may be referred to carrier index. In implementation, the physical cell ID or cell index may be assigned to a cell. Cell ID may be determined using the synchronization signal transmitted on a downlink carrier. Cell index may be determined using RRC messages. For example, when the specification refers to a first physical cell ID for a first downlink carrier, it may mean the first physical cell ID is for a cell comprising the first downlink carrier. The same concept may apply to, for example, carrier activation. When the specification indicates that a first carrier is activated, it equally means that the cell comprising the first carrier is activated.

Embodiments may be configured to operate as needed. The disclosed mechanism may be performed when certain criteria are met, for example, in wireless device, base station, radio environment, network, a combination of the above, and/or the like. Example criteria may be based, at least in part, on for example, traffic load, initial system set up, packet sizes, traffic characteristics, a combination of the above, and/or the like. When the one or more criteria are met, the example embodiments may be applied. Therefore, it may be possible to implement example embodiments that selectively implement disclosed protocols.

Example embodiments of the invention may reconfigure a connection in a multicarrier OFDM communication system. Other example embodiments may comprise a non-transitory tangible computer readable media comprising instructions executable by one or more processors to cause reconfiguration of a connection in a multicarrier OFDM communication system. Yet other example embodiments may comprise an article of manufacture that comprises a non-transitory tangible computer readable machine-accessible medium having instructions encoded thereon for enabling programmable hardware to cause a device (e.g. wireless communicator, UE, base station, etc.) to reconfigure a connection in a multicarrier OFDM communication system. The device may include processors, memory, interfaces, and/or the like. Other example embodiments may comprise communication networks comprising devices such as base stations, wireless devices (UE), servers, switches, antennas, and/or the like.

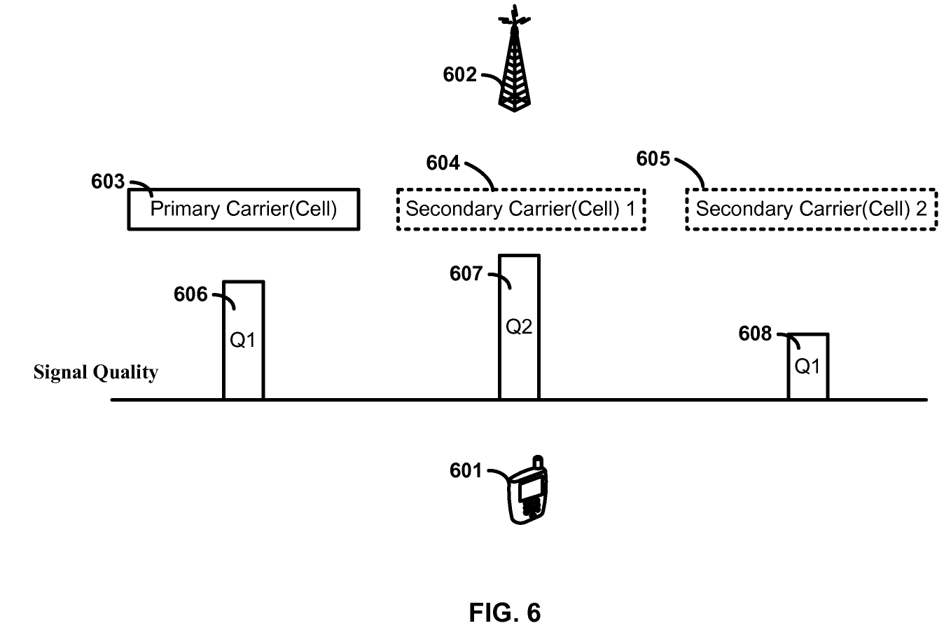

A base station and/or a wireless device in a communication network may be configured to communicate employing a plurality of cells. Each cell may include a downlink carrier and one or zero uplink carrier. Each of the plurality of carriers may comprise a plurality of OFDM subcarriers. FIG. 6 is a diagram illustrating measurement results for at least one secondary carrier as per an aspect of an embodiment of the present invention. According to some of the various aspects of embodiments, the base station 602 may transmit a first control message to a wireless device 601 on a first carrier in the plurality of carriers to establish a first signaling bearer with the wireless device on the first carrier 603. The base station may receive a plurality of radio capability parameters from the wireless device on the first signaling connection on an uplink channel over the first carrier. The base station may transmit at least one control message to the wireless device 601 on the first carrier. The at least one control message may be configured to cause configuration of a first connection comprising at least one data radio bearer and a second signaling bearer with the wireless device. At least some parameters in the at least one second control message may depend, at least in part, on the plurality of radio capability parameters received from said wireless device. The configuration may be based on the plurality of radio capability parameters received from the wireless device. At least one of the at least one control message may be configured to cause configuration of measurement parameters of the wireless device. The measurement configuration may trigger measurements of signal quality of at least a second carrier in the plurality of carriers. In an example embodiment, wireless device 601 may measure signal quality of carrier 603, 604 and/or 605. In another example embodiment, the wireless device 601 may only measure the signal quality of inactive carriers 604, 605, or may measure the signal quality of one secondary carrier candidate, for example secondary carrier 604. As an example, the measured signal quality 606, 607, and 608 are shown in FIG. 6.

The base station may receive at least one measurement report from the wireless device 601 in response to the second control message. The at least one measurement report may comprise signal quality information of a first plurality of OFDM subcarriers of at least one second carrier. In an example embodiment, the base station 602 may transmit a third control message to the wireless device 601. The third control message may cause reconfiguration of the first connection. The reconfiguration may comprise adding the second carrier 604 to the first connection if the at least one measurement report indicates an acceptable signal quality for the second carrier. In the example of FIG. 6, secondary carrier 604 has an acceptable signal quality 607. In another example embodiment, if the secondary carrier(s) are already configured and are inactive, the base station may transmit an activation command to activate at least one secondary carrier, for example carrier 604. In an example embodiment, the base station 602 may transmit, selectively, based on one or more criterion, an RRC reconfiguration message or an activation command to said wireless device 601. If the at least one secondary carrier is not configured, the base station 602 may first transmit an RRC message and then may transmit the activation command. If the at least one secondary carrier is already configured, there may not be a need for a RRC reconfiguration message to add the at least one secondary carrier (secondary cell). The activation command may be configured to cause the activation of at least one of the at least one second carrier in the wireless device. The one or more criterion may comprise the at least one measurement report indicating an acceptable signal quality for the at least one of the at least one second carrier.

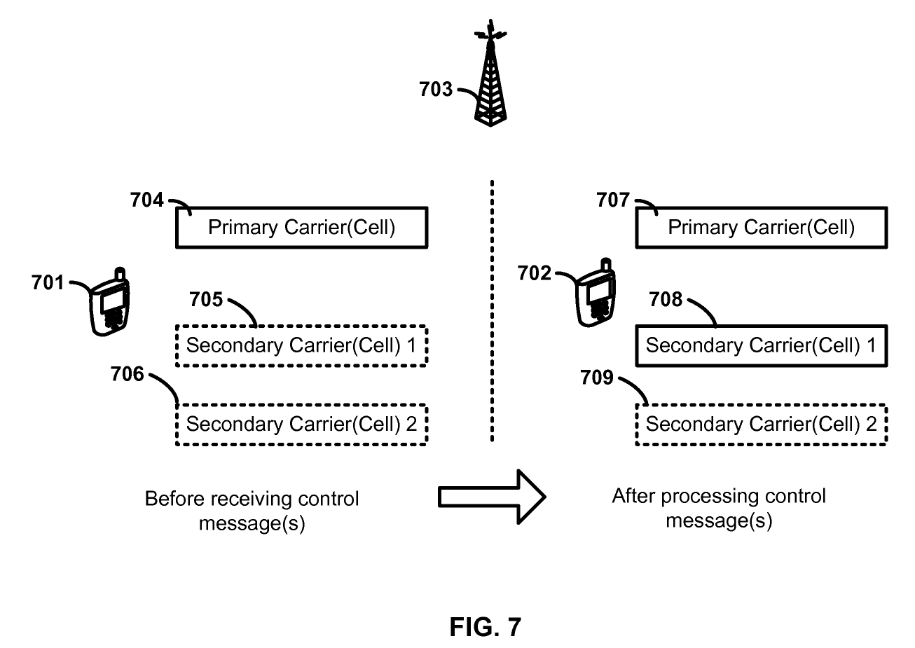

FIG. 7 is an diagram depicting example changes in carrier configuration and/or activation after control message(s) are processed as per an aspect of embodiments of the present invention. Before receiving control messages, primary carrier (cell) 704 may be configured and active, and secondary carriers 705 and 706 may be inactive and/or not configured yet. If the secondary carrier (cell) 705 is not configured yet, the RRC reconfiguration message may add the secondary carrier 708 to the configuration, but may or may not change the configuration of carrier 709. At least two carriers may be configured in wireless device 702. Wireless device 702 may be a reconfigured wireless device 701. The base station 703 may transmit an activation command to the wireless device 702. The activation command may activate the second carrier 708. The control message(s) may be an RRC reconfiguration message and MAC activation message (command) if the secondary carrier is not configured. If the secondary carrier is already configured, the control message may comprise the MAC activation command and an RRC message may not necessarily be needed. The base station 703 may transmit the data traffic to the wireless device 702 on a second plurality of OFDM subcarriers in the first carrier(cell) 707 and the second carrier (cell) 708. First carrier(cell) 707 may be a reconfigured first carrier(cell) 704.

According to some of the various aspects of embodiments, the first control message may comprise MAC and physical layer configuration(s). The first control message may be an RRC connection set up message. The wireless device may transmit a response message after it receives the first control message. The response message may comprise a preferred PLMN ID. The base station may transmit a request to the wireless device on the first signaling bearer before the plurality of radio capability parameters are received. The first signaling radio bearer may be mapped to a dedicated control channel. The second signaling radio bearer may be mapped to a dedicated control channel. The first control message may be transmitted on a common control channel.

There may be at least a guard band between each two carriers in the plurality of carriers. The plurality of carriers may be transmitted by the wireless base station. A scheduling control packet may be transmitted before each packet of the data traffic is transmitted. The scheduling control packet may comprise information about the subcarriers used for packet transmission. Transmission time may be divided into a plurality of subframes. Subframe timing of the second carrier may be synchronized with subframe timing of the first carrier.

According to some of the various aspects of embodiments, the plurality of radio capability parameters may comprise an antenna configuration of the wireless device. The at least one control message may configure the signal quality metric that the wireless device may measure. The at least one control message may configure a measurement reporting criteria. The signal quality information may comprise signal strength. The signal quality information may comprise a signal to interference ratio. A signal quality may be considered acceptable, if the value of the signal quality is above a threshold or if the value of the signal quality is in an acceptable range.

The base station may maintain a deactivation timer for the second carrier of the wireless device. The base station may change the activation state of the second carrier of the wireless device to an inactive state after the associated deactivation timer expires. When a packet in the data traffic is transmitted on the second carrier to the wireless device, the deactivation timer associated with the second carrier may be restarted. The at least one data radio bearer may comprise a non-GBR bearer. The at least one control message may comprise an RRC connection reconfiguration message. The second carrier may be in a different frequency band than the first carrier. The data traffic may be encrypted before transmission.

According to some of the various aspects of embodiments, a base station may communicate IMS data and signaling traffic to a wireless device. The base station may transmit a first control message to the wireless device on a first carrier in the plurality of carriers to establish a first signaling bearer with the wireless device over the first carrier(cell). The base station may receive a plurality of radio capability parameters from the wireless device on the first signaling bearer on an uplink channel corresponding to the first carrier.

The base station may transmit at least one second control message to the wireless device on the first carrier. The at least one second control message may be configured to cause configuration of a first connection comprising at least one data radio bearer. The first connection may comprise a second signaling bearer with the wireless device. At least some parameters in the at least one second control message may depend, at least in part, on the plurality of radio capability parameters received from the wireless device. The configuration may be based, at least in part, on the plurality of radio capability parameters received from the wireless device. One of the at least one data radio bearer may be used for IMS signaling traffic. In another example, IMS signaling traffic may be carried over a default data bearer. At least one of the at least one second control message may be configured to cause the configuration of measurement parameters of the wireless device. The measurement configuration may trigger measurements of signal quality of at least one second carrier in the plurality of carriers.

The base station may receive at least one measurement report from the wireless device in response to the second control message. The at least one measurement report may comprise signal quality information of a first plurality of OFDM subcarriers of the second carrier. The signal quality information derived at least in part employing measurements of at least one OFDM subcarrier. The base station may transmit at least one third control message to the wireless device. The at least one third control message may cause reconfiguration of the first connection. The at least one third control message may cause adding a second data radio bearer to the first traffic connection for carrying the IMS data traffic. The establishment of the second data radio bearer may be triggered by the network. For example, an IMS application server, a P-GW, and/or PCRF may initiate the bearer establishment or may be involved in establishment of the second data radio bearer. The reconfiguration may comprise adding the second cell to the first connection (if the second carrier is needed and if it is not already configured). If needed, the second cell may be added if the at least one measurement report indicates an acceptable signal quality for the second carrier.

The base station may transmit, selectively, based on one or more criterion, an activation command to the wireless device. The activation command may be configured to cause the activation of at least one of the at least one second carrier for the wireless device. The one or more criterion may comprise the at least one measurement report indicating an acceptable signal quality for the at least one of the at least one second carrier. The base station may transmit at least a portion of the IMS data traffic to the wireless device on a second plurality of OFDM subcarriers in the first carrier and the second carrier using the second data radio bearer.

A scheduling control packet may be transmitted before each packet of the IMS data traffic is transmitted. The scheduling control packet may comprise information about the subcarriers used for packet transmission. The at least one second control message may configure the signal quality metric that the wireless device shall measure. The at least one second control message may configure measurement reporting criteria. The at least one data radio bearer may comprise a non-GBR bearer. The second data radio bearer may be a GBR bearer. The at least one second control message may comprise an RRC connection reconfiguration message. The IMS data and signaling traffic may be encrypted before transmission.

According to some of the various aspects of embodiments, a wireless device may receive a first control message from a base station on a first carrier in the plurality of carriers to establish a first signaling bearer with the base station on the first carrier. The wireless device may transmit a plurality of radio capability parameters to the base station on the first signaling connection on an uplink carrier corresponding to the first carrier. The wireless device may receive at least one control message from the base station on the first carrier. At least some parameters in the at least one control message may depend, at least in part, on the plurality of radio capability parameters. The at least one control message may cause the wireless device to configure a first connection comprising at least one data radio bearer and a second signaling bearer with the base station. The configuration may be based, at least in part, on the plurality of radio capability parameters transmitted to the base station. At least one of the at least one control message may further cause the wireless device to configure measurement parameters of the wireless device. The measurement configuration may trigger measurements of signal quality of at least one second carrier in the plurality of carriers.

The wireless device may transmit at least one measurement report to the base station in response to the second control message. The at least one measurement report may comprise signal quality information of a first plurality of OFDM subcarriers of at least one second carrier. The signal quality information derived at least in part employing measurements of at least one OFDM subcarrier. In an example embodiment, the wireless device may receive a third control message from the base station, the third control message may cause the wireless device to reconfigure the first connection. The reconfiguration may comprise adding at least one second carrier to the first connection if the at least one measurement report indicates an acceptable signal quality for the at least one second carrier. In another example embodiment, if the secondary carriers are already configured and are inactive, the base station may transmit an activation command to activate at least one secondary carrier. In an example embodiment, the base station may transmit, selectively, based on one or more criterion, an RRC reconfiguration message or an activation command to the wireless device. If a secondary carrier is not configured the base station first transmits an RRC message and then transmit the activation command. If the secondary carrier is already configured, there may not be a need for RRC reconfiguration message for adding the secondary carrier (secondary cell). The activation command configured to cause the activation of at least one of the at least one second carrier in the wireless device. The one or more criterion may comprise the at least one measurement report indicating an acceptable signal quality for the at least one of the at least one second carrier. The wireless device may receive an activation command from the base station. The activation command may activate the second carrier. The wireless device may receive the data traffic from the base station on a second plurality of OFDM subcarriers in the first carrier and the second carrier.

According to some of the various aspects of embodiments, the first control message may comprise a MAC and physical layer configuration. The first control message may be an RRC connection set up message. The wireless device may transmit a response message after it receives the first control message. The response message may comprise a preferred PLMN ID. The base station may transmit a request to the wireless device on the first signaling bearer before the plurality of radio capability parameters are transmitted. The first signaling radio bearer may be mapped to a dedicated control channel. The second signaling radio bearer may be mapped to a dedicated control channel. The first control message may be transmitted on a common control channel.

There may be at least a guard band between each two carriers in the plurality of carriers. The plurality of carriers may be transmitted by the wireless base station. A scheduling control packet may be received before each packet of the data traffic is received. The scheduling control packet may comprise information about the subcarriers used for packet transmission. Reception time is divided into a plurality of subframes. Subframe timing of the second carrier may be synchronized with subframe timing of the first carrier.

The plurality of radio capability parameters may comprise antenna configuration of the wireless device. The at least one control message may configure the signal quality metric that the wireless device shall measure. The at least one control message may configure measurement reporting criteria. The signal quality information may comprise signal strength. The signal quality information may comprise signal to interference ratio. A signal quality may be considered acceptable, if the value of the signal quality is above a threshold or if the value of the signal quality is in an acceptable range.

The wireless device may maintain a deactivation timer for the second carrier. The wireless device may deactivate the second carrier after the associated deactivation timer expires. When a packet in the data traffic is received on the second carrier, the deactivation timer associated with the second carrier may be restarted. The at least one data radio bearer may comprise a non-GBR bearer. The at least one control message may comprise an RRC connection reconfiguration message. The second carrier may be in a different frequency band than the first carrier. The data traffic may be decrypted after being received.

According to some of the various aspects of embodiments, a wireless device may receive IMS data and signaling traffic from a base station. The wireless device and the base station may be configured to communicate employing a plurality of cells. The wireless device may receive a first control message from a base station on a first carrier in the plurality of carriers to establish a first signaling bearer with the base station on the first carrier. The wireless device may transmit a plurality of radio capability parameters to the base station on the first signaling connection on an uplink channel corresponding to the first carrier.

The wireless device may receive at least one second control message from the base station on the first carrier. At least some parameters in the at least one control message may depend, at least in part, on the plurality of radio capability parameters. The at least one second control message may cause the wireless device to configure a first connection comprising at least one data radio bearer and a second signaling bearer with the base station. The configuration may be based, at least in part, on the plurality of radio capability parameters transmitted to the base station. One of the at least one data radio bearer may be used for IMS signaling traffic. In another example, IMS signaling traffic may be carried over a default data bearer. At least one of the at least one second control message may cause the wireless device to configure measurement parameters of the wireless device. The measurement configuration may trigger measurements of signal quality of at least one second carrier in the plurality of carriers.

The wireless device may transmit at least one measurement report to the base station in response to the second control message. The at least one measurement report may comprise signal quality information of a first plurality of OFDM subcarriers of the at least one second carrier. The wireless device may receive at least one third control message from the base station.

The at least one third control message may cause the wireless device to reconfigure the first connection. It may cause adding a second data radio bearer to the first traffic connection for carrying the IMS data traffic. The establishment of the second data radio bearer may be triggered by the network. For example, an IMS application server, a P-GW, and/or PCRF may initiate the bearer establishment or may be involved in establishment of the second data radio bearer. The reconfiguration may comprise adding the second cell to the first connection (if the second carrier is needed and if it is not already configured). The second cell may be added, if the at least one measurement report indicates an acceptable signal quality for the second carrier.

Base station may transmit, selectively, based on one or more criterion, an activation command to the wireless device. The activation command may be configured to cause the activation of at least one of the at least one second carrier in the wireless device. The one or more criterion may comprise the at least one measurement report indicating an acceptable signal quality for the at least one of the at least one second carrier. The wireless device may receive an activation command from the base station. The activation command may cause activation of at least one second carrier. The wireless device may receive the IMS data traffic from the base station on a second plurality of OFDM subcarriers in the first carrier and the second carrier using the second data radio bearer.

A scheduling control packet may be received before each packet of the IMS data traffic is received. The scheduling control packet may comprise information about the subcarriers used for packet transmission. The at least one second control message may configure the signal quality metric that the wireless device shall measure. The at least one second control message may configure measurement reporting criteria. The at least one data radio bearer may comprise a non-GBR bearer. The second data radio bearer may be a GBR (guaranteed bit rate) bearer. The at least one second control message may comprise an RRC connection reconfiguration message. The IMS data and signaling traffic may be decrypted after being received. The first data radio bearer may be a non-GBR bearer. The second data radio bearer may be a non-GBR bearer. The third data radio bearer may be a GBR bearer.

According to some of the various aspects of embodiments, a base station may transmit data traffic using carrier aggregation to a wireless device. The base station and/or the wireless device may be configured to communicate employing a plurality of downlink carriers and a plurality of uplink carriers (a plurality of cells). Each of the plurality of downlink carriers and each of the plurality of uplink carriers may comprise a plurality of subcarriers. The base station may receive a first random access preamble on a first plurality of subcarriers from the wireless device on a first uplink carrier in the plurality of uplink carriers. The wireless device transmitting the first random access preamble may be in RRC-Idle mode. The wireless device may initiate the random access process in order to connect to the base station and move to RRC-connected mode. The base station may transmit an RRC establishment message on a first data channel on a first downlink carrier. The RRC establishment message may establish a first signaling bearer. The first signaling bearer may be established on the first downlink carrier and the first uplink carrier. The first downlink carrier corresponds to the first uplink carrier.

The base station may establish a security context with the wireless device using the first signaling bearer. The base station may transmit an RRC reconfiguration message on the first data channel on the first downlink carrier directing the wireless device to connect to a second downlink carrier in the plurality of downlink carriers. The base station may receive a second random access preamble on a second plurality of subcarriers from the wireless device on a second uplink carrier in the plurality of uplink carriers. The second uplink carrier corresponds to the second downlink carrier. In another implementation option, the base station may not receive a second random access preamble on the second uplink carrier. The base station may transmit a plurality of data packets on the first downlink carrier and the second downlink carrier to the wireless device, which is now in RRC-connected mode. In another example, the base station may transmit a plurality of data packets on the second downlink carrier to the wireless device, and the first carrier in the wireless device may be deactivated or released. The base station may transmit an activation command to the wireless device to activate the first cell and may transmit some of the plurality of data packets on the first downlink carrier. The base station may receive control data over a physical uplink control channel on the second uplink carrier. The control data may comprise: a) positive/negative acknowledgements for some of the data packets transmitted on the first downlink carrier and/or the second downlink carrier, b) channel state information for the first downlink carrier and/or the second downlink carrier, c) scheduling request, and/or a combination of the above. The control data may have a variety of pre-defined format. Each instance of control data transmitted in one subframe, may comprise, for example, positive acknowledgement, negative acknowledgement, channel state information, scheduling request, and/or a combination of the above.

According to some of the various aspects of embodiments, the wireless device may not employ a physical uplink control channel on the second uplink carrier when the wireless device is in the configuration preceding the RRC reconfiguration message is received. The wireless device may not use a physical uplink control channel on the first uplink carrier after the RRC reconfiguration message is processed and until another RRC message is received and until the wireless device is reconfigured again or disconnected. In an example embodiment, no data packet may be transmitted on the first downlink carrier or on the second downlink carrier before the RRC reconfiguration message is processed. In an example implementation, the change in uplink control channel may happen right after the wireless device is connected to the base station. The base station may redirect the wireless device to another carrier, for example, for load balancing, scheduling, or the policy or scheduling reasons. In the process above, the primary carrier(cell) changes from a first carrier(cell) to a second carrier(cell). If a channel state information, and positive and negative acknowledgements are piggybacked on data packets transmitted on the first uplink carrier or the second uplink carrier, then the channel state information, and positive and negative acknowledgements may not be transmitted on the physical uplink control channel.

According to some of the various aspects of embodiments, a paging signal may be transmitted to the wireless device on the first downlink carrier before receiving the first random access preamble. The first downlink carrier and the second downlink carrier may have acceptable signal quality. Acceptable signal quality may be imply signal strength, signal to interference ratio, and/or bit or block error rate which is in an acceptable range. The RRC reconfiguration message may be transmitted to achieve load balancing, when a load of the first uplink carrier and the second uplink carrier are substantially different. Other example methods may be used to define a carrier or cell load. The load may be the load of uplink control channel. The load may be the number of wireless devices with a given downlink carrier as their primary carrier. The RRC reconfiguration message may be transmitted when a load of the first downlink carrier and the second downlink carrier are substantially different. The load may be the load of downlink control channel. The load may be the number of wireless devices with certain downlink carrier as their primary carrier. In another example, a combination of factors may be used to define a cell load.

According to some of the various aspects of embodiments, the first uplink carrier and the second uplink carrier may be the same carrier or different carriers depending on uplink configuration. A secondary cell in an LTE network may not include an uplink carrier. Therefore, the number of uplink carriers may be less than the number of downlink carriers. One of the downlink carriers may not have a corresponding uplink carrier. Depending on implementation, this may imply that one uplink carrier corresponds to both downlink carriers. In the process the primary carrier for wireless device changes from one cell to another one, and the cell may employ the same uplink carrier before and after the change.

According to some of the various aspects of embodiments, a base station may transmit data traffic using carrier aggregation to a wireless device. The base station and/or the wireless device may be configured to communicate employing a plurality of downlink carriers and a plurality of uplink carriers. The base station may comprise at least one communication interface, at least one processor, and memory storing instructions that, when executed, cause the base station to perform certain functions. The base station may transmit a plurality of data packets on a first downlink carrier and a second downlink carrier to the wireless device. In another example, the base station may transmit a plurality of data packets on the first downlink carrier to the wireless device, and the second carrier in the wireless device may be deactivated or released. The base station may transmit an activation command to the wireless device to activate the first cell and may transmit some of the plurality of data packets on the second downlink carrier. The first downlink carrier may carry the broadcast control information for the wireless device. In an example implementation, the broadcast control information may be transmitted on both first downlink carrier and the second downlink carrier, and the wireless device may receive the broadcast control information from the first downlink carrier and not from the second downlink carrier. The wireless may receive the broadcast system information blocks from the first downlink carrier and not from the second downlink carrier. While the broadcast control information is transmitted on both carriers, the wireless device receives the broadcast control information from the first downlink carrier. The wireless device may maintain a deactivation timer and may activate or deactivate the second carrier (cell) when the deactivation timer expires or when the wireless device receives a deactivation command from the base station. The base station maintains the activation state of the second carrier (cell) associated with the wireless device, and may change the cell state from activation to deactivation when a deactivation timer in the base station for the second carrier (cell) associated with the wireless device expires. The base station may configure the second cell, and selectively employ the second carrier when it is needed. The base station may transmit control and data messages over the first downlink carrier and/or over the second downlink carrier. The base station may cause activation of the second cell in the wireless device and selectively transmit control and data packets employing the second downlink carrier.

The base station may receive a first control data over a first physical uplink control channel on the first uplink carrier. The first uplink carrier corresponds to the first downlink carrier. The first control data may comprise at least one of: a) positive/negative acknowledgements for data packets transmitted on the first downlink carrier and/or the second downlink carrier, b) channel state information for the first downlink carrier and/or the second downlink carrier, c) a scheduling request, or a combination of the above. The control data may have a variety of pre-defined format. Each instance of control data transmitted in one subframe, may comprise, for example, positive acknowledgement, negative acknowledgement, channel state information, scheduling request, and/or a combination of the above. The base station may transmit at least one control message to the wireless device. The at least one control message may reconfigure the configuration of the first carrier (cell) and the second carrier (cell) of the wireless device. In an example embodiment, reconfiguration of the first carrier (cell), may imply releasing the first carrier (cell). The base station may transmit a plurality of data packets on the first downlink carrier and/or the second downlink carrier to the wireless device. The second downlink carrier carries the broadcast control information for the wireless device. In an example embodiment, the broadcast control information may be transmitted on both carriers, but the wireless device receives the broadcast control information from the second downlink carrier and not from the first downlink carrier. The wireless may receive the broadcast system information blocks from the second downlink carrier and not from the first downlink carrier. The base station may receive a second control data over a second physical uplink control channel on a second uplink carrier. The second uplink carrier corresponds to the second downlink carrier. While the broadcast control information is transmitted on both carriers, the wireless device receives the broadcast control information from the second downlink carrier. The wireless device may maintain a deactivation timer and may activate or deactivate the first carrier (cell) when the deactivation timer expires or when the wireless device receives a deactivation command from the base station. The base station maintains the activation state of the first carrier (cell) associated with the wireless device, and may change the cell state from activation to deactivation when a deactivation timer in the base station for the first carrier (cell) associated with the wireless device expires. The base station may configure the first cell, and selectively employ the first carrier when it is needed. The base station may transmit control and data messages over the second downlink carrier and/or over the first downlink carrier. The base station may cause activation of the first cell in the wireless device and selectively transmit control and data packets employing the first downlink carrier.

The at least one control message may be transmitted when a load of the first uplink carrier and the second uplink carrier are substantially different. The load may be defined according to various different cell parameters depending on implementation. For example, the load may be the load of uplink control channel. The load may be the number of wireless devices with certain downlink carrier as their primary carrier. The at least one control message may be transmitted when a load of the first downlink carrier and the second downlink carrier are substantially different. The load may be the load of downlink control channel. The load may be the number of wireless devices with certain downlink carrier as their primary carrier. The at least one control message may be transmitted to the wireless device, if a signal quality of the second downlink carrier is above the signal quality of the first downlink carrier by a threshold margin. The threshold margin may be any value above or equal to zero. The first uplink carrier and the second uplink carrier may be the same carrier or may be different carriers.

According to some of the various aspects of embodiments, a base station may transmit data traffic using carrier aggregation to a wireless device. The base station and/or the wireless device may be configured to communicate employing a plurality of downlink carriers and a plurality of uplink carriers. The base station may transmit a plurality of data packets on a first downlink carrier and a second downlink carrier to the wireless device. The first downlink carrier may carry the broadcast control information for the wireless device. In an example implementation, the wireless device receives the broadcast control information from the first downlink carrier and not from the second downlink carrier. The wireless may receive the broadcast system information blocks from the first downlink carrier and not from the second downlink carrier.

The base station may receive a first control data over a first physical uplink control channel on a first uplink carrier. The first uplink carrier corresponds to the first downlink carrier. The first physical uplink control channel may comprise at least one of: a) positive/negative acknowledgements for data packets transmitted on the first downlink carrier and the second downlink carrier, b) channel state information for the first downlink carrier and the second downlink carrier, c) scheduling request, and/or a combination of the above. The base station may transmit at least one control message to the wireless device. The at least one control message may reconfigure the configuration of the first carrier (cell) and the second carrier (cell) of the wireless device. In an example embodiment, the first cell reconfiguration may imply that the first cell is released. The base station may transmit a plurality of data packets on the second downlink carrier to the wireless device. The second downlink carrier carries the broadcast control information for the wireless device. In an example embodiment, the wireless device may receive the broadcast control information from the second downlink carrier and not from the first downlink carrier. The wireless may receive the broadcast system information blocks from the second downlink carrier and not from the first downlink carrier. The base station may receive a second physical uplink control channel on a second uplink carrier. The second uplink carrier corresponds to the second downlink carrier. The base station may receive a second control data over a second physical uplink control channel. The second physical uplink control channel may comprise at least one of: a) positive and negative acknowledgements for data packets on the second downlink carrier, b) channel state information for the second downlink carrier, c) a scheduling request, and or a combination of the above.

According to some of the various aspects of embodiments, a wireless device may receive data traffic using carrier aggregation from a base station. The base station and/or the wireless device may be configured to communicate employing a plurality of downlink carriers and a plurality of uplink carriers. Each of the plurality of downlink carriers and each of the plurality of uplink carriers may comprise a plurality of subcarriers. The wireless device comprises at least one communication interface, at least one processor, and memory storing instructions that, when executed, cause the wireless device to perform certain functions. When wireless device is in RRC-Idle mode, the wireless device may transmit a first random access preamble on a first plurality of subcarriers to the base station on a first uplink carrier in the plurality of uplink carriers. The wireless device may receive an RRC establishment message on a first data channel on a first downlink carrier. The RRC establishment message may establish a first signaling bearer. The first signaling bearer may be established on the first downlink carrier and the first uplink carrier. The first downlink carrier corresponds to the first uplink carrier. The wireless device may establish a security context with the base station using the first signaling bearer.

The wireless device may receive an RRC reconfiguration message on the first data channel on the first downlink carrier directing the wireless device to connect to a second downlink carrier in the plurality of downlink carriers. The wireless device may transmit a second random access preamble on a second plurality of subcarriers to the base station on a second uplink carrier in the plurality of uplink carriers. The second uplink carrier corresponds to the second downlink carrier. In an example embodiment, the wireless device may not transmit a second random access preamble. The wireless device may receive a plurality of data packets on the first downlink carrier and the second downlink carrier from the base station. In another example, the base station may transmit a plurality of data packets on the second downlink carrier to the wireless device, and the first carrier (cell) in the wireless device may be deactivated or released. The base station may transmit an activation command to the wireless device to activate the first cell and may transmit some of the plurality of data packets on the second downlink carrier. The wireless device may transmit control data over a physical uplink control channel on the second uplink carrier. The control data may comprise at least one of: a) positive/negative acknowledgements for some of data packets received on the first downlink carrier and the second downlink carrier, b) channel state information for the first downlink carrier and the second downlink carrier, c) a scheduling request, and/or a combination of the above.

According to some of the various aspects of embodiments, the wireless device may not use a physical uplink control channel on the second uplink carrier when the wireless device is in the configuration preceding to the RRC reconfiguration message is received. The wireless device may not use a physical uplink control channel on the first uplink carrier after the RRC reconfiguration message is processed and until it receives another RRC message or when configuration of wireless device changed, for example the wireless device is turned off or restarts another random access process. In an example embodiment, no data packet may be received on the first downlink carrier or on the second downlink carrier before the RRC reconfiguration message is processed. If a channel state information, and positive and negative acknowledgements are piggybacked on data packets transmitted on the first uplink carrier or the second uplink carrier, then the channel state information, and positive and negative acknowledgements may not be transmitted on the physical uplink control channel. A paging signal may be received from the base station on the first downlink carrier before transmitting the first random access preamble. The first downlink carrier and the second downlink carrier may have acceptable signal quality. The RRC reconfiguration message may be received when a load of the first uplink carrier and the second uplink carrier are substantially different. There may be different ways to define a carrier (cell) load. For example, the load may be the load of uplink control channel. The load may be the number of wireless devices with a given downlink carrier as their primary carrier. The RRC reconfiguration message may be received when a load of the first downlink carrier and the second downlink carrier are substantially different. The load may be the load of downlink control channel. The load may be the number of wireless devices with certain downlink carrier as their primary carrier. In an example embodiment, the first uplink carrier and the second uplink carrier may be the same carrier or different carriers.

According to some of the various aspects of embodiments, a wireless device may receive data traffic using carrier aggregation from a base station. The wireless device and/or the base station may be configured to communicate employing a plurality of downlink carriers and a plurality of uplink carriers. Each of the plurality of downlink carriers and each of the plurality of uplink carriers comprises a plurality of subcarriers. The wireless device may receive a plurality of data packets on a first downlink carrier and a second downlink carrier from the base station. The wireless device may receive broadcast control information from the first downlink carrier. The wireless may receive the broadcast system information blocks from the first downlink carrier and not from the second downlink carrier. The wireless device may maintain a deactivation timer and may activate or deactivate the second carrier (cell) when the deactivation timer expires or when the wireless device receives a deactivation command from the base station. The base station maintains the activation state of the second carrier (cell) associated with the wireless device, and may change the cell state from activation to deactivation when a deactivation timer in the base station for the second carrier (cell) associated with the wireless device expires. The base station may configure the second cell, and selectively employ the second carrier when it is needed. The base station may transmit control and data messages over the first downlink carrier and/or over the second downlink carrier. The base station may cause activation of the second cell in the wireless device and selectively transmit control and data packets employing the second downlink carrier. The wireless device may transmit a first control data over a first physical uplink control channel on a first uplink carrier. The first uplink carrier corresponds to the first downlink carrier. The first control data may comprise at least one of: a) positive and negative acknowledgements for some of data packets received on the first downlink carrier and the second downlink carrier, b) channel state information for the first downlink carrier and the second downlink carrier, scheduling request message, or a combination of the above.

The wireless device may transmit at least one measurement report to the base station. The at least one control message measurement report may comprise signal quality information of a first plurality of OFDM subcarriers of the first downlink carrier, and a second plurality of OFDM subcarriers of the second downlink carrier. The at least one control message measurement report may be transmitted employing RRC messages or first control data over the first physical uplink control channel. The wireless device may receive at least one control message from the base station, if the at least one control message measurement report meets a plurality of predefined criteria. The at least one control message may reconfigure the configuration of the first cell (carrier) and the second cell (carrier) of the wireless device. In an example embodiment, reconfiguration of the first cell may imply releasing the first cell. The wireless device may receive a plurality of data packets on the first downlink carrier and the second downlink carrier from the base station. In another example, the base station may transmit a plurality of data packets on the second downlink carrier to the wireless device, and the first carrier (cell) in the wireless device may be deactivated or released. The base station may transmit an activation command to the wireless device to activate the first cell and may transmit some of the plurality of data packets on the second downlink carrier. The wireless device may receive broadcast control information only from the second downlink carrier. The wireless may receive the broadcast system information blocks from the second downlink carrier and not from the first downlink carrier. The wireless device may transmit second control data over a physical uplink control channel on a second uplink carrier. The second uplink carrier corresponds to the second downlink carrier. The second control data may comprise at least one of: a) positive and negative acknowledgements for some of data packets received on the first downlink carrier and/or the second downlink carrier, b) channel state information for the first downlink carrier and/or the second downlink carrier, scheduling request message, or a combination of the above. In an example embodiment, the first uplink carrier and the second uplink carrier may be the same carrier or different carriers. The plurality of predefined criteria may comprise satisfying a condition, in which the signal quality of the second downlink carrier is above the signal quality of the first downlink carrier by a threshold margin. The threshold margin may be above or equal to zero.

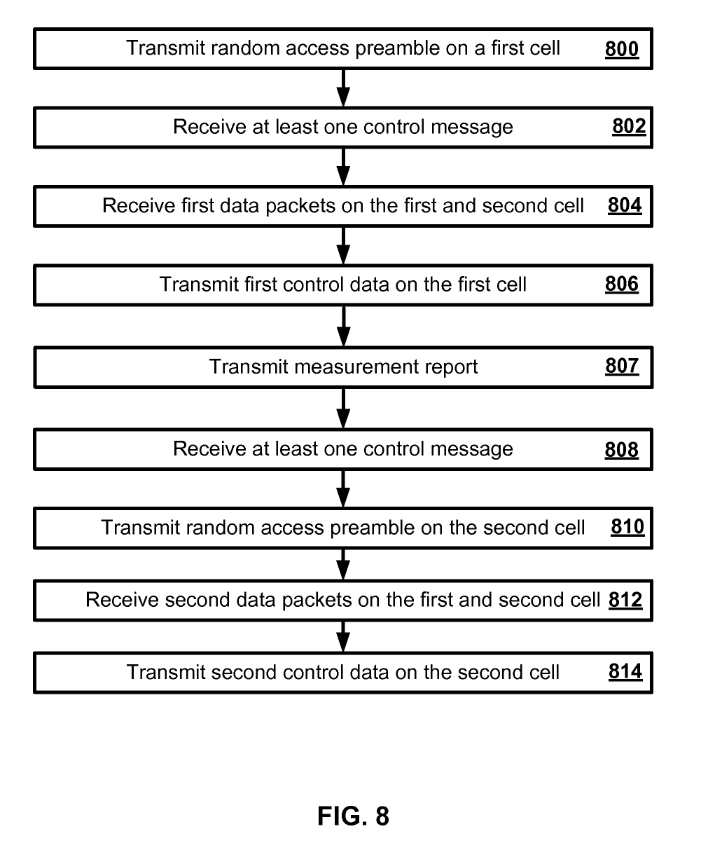

FIG. 8 is an example flow chart for carrier reconfiguration as per an aspect of an embodiment of the present invention. The process is between a base station and a wireless device. According to some of the various aspects of embodiments. The base station and/or the wireless device may be configured to communicate employing a plurality of downlink carriers and a plurality of uplink carriers. Each of the plurality of downlink carriers and each of the plurality of uplink carriers may comprise a plurality of subcarriers. When wireless device is in RRC-Idle mode, the wireless device may transmit a first random access preamble on a first plurality of subcarriers to the base station on a first uplink carrier in the plurality of uplink carriers as shown in task 800. The wireless device may receive a random access response (RAR) from the base station on the first cell. The RAR may comprise timing advance and an uplink grant. The wireless device may receive at least one control message/command as shown in 802. The wireless device may receive an RRC establishment message on a first data channel on a first downlink carrier. The RRC establishment message may establish a first signaling bearer. The first signaling bearer may be established on the first downlink carrier and the first uplink carrier. The first downlink carrier corresponds to the first uplink carrier. The wireless device may establish a security context with the base station using the first signaling bearer. The wireless device may receive an RRC message for configuring the second cell(carrier) and a MAC activation message activate the second cell(carrier).

The wireless device may receive data traffic using carrier aggregation from a base station. The wireless device may receive a plurality of data packets on a first downlink carrier and a second downlink carrier from the base station as shown in task 804. The wireless device may receive broadcast control information and system information blocks from the first downlink carrier. The wireless device may transmit a first control data over a first physical uplink control channel on the first uplink carrier as shown in task 806. The first uplink carrier corresponds to the first downlink carrier. The physical uplink control channel may comprise at least one of: a) positive and negative acknowledgements for some of the data packets received on the first downlink carrier and the second downlink carrier, b) channel state information for the first downlink carrier and the second downlink carrier, c) scheduling request, and/or a combination of the above. The wireless device may transmit at least one measurement report to the base station as shown in task 807. The wireless device may receive at least one control message from the base station as shown in task 808. In an example embodiment, base station may transmit at least one of the at least one control message in response to the measurement report. For example, when the signal quality of the first downlink and/or second downlink carrier falls in a given range, or the different between them falls in a given range, or when some other QoS parameters such bit error rate or block error rate falls within a given range. The at least one control message may reconfigure the configuration of the wireless device. One of the at least one control message may be an RRC message directing the wireless device to connect to a second downlink carrier in the plurality of downlink carriers. The wireless device may transmit a second random access preamble on a second plurality of subcarriers to the base station on a second uplink carrier in the plurality of uplink carriers as shown in task 810. The wireless device may receive a random access response (RAR) from the base station on the second cell. The RAR may comprise timing advance and an uplink grant. The wireless device may receive an RRC message for configuring the first cell(carrier) and a MAC activation message activate the first cell(carrier). Configuration and activation of the first cell may not be performed according to base station determination. For example, if base station the first cell does not enough quality, is congested, is not needed, and/or the like.

The wireless device may receive a plurality of data packets on the first downlink carrier (if first cell is activated) and the second downlink carrier from the base station as shown in task 812. The wireless device may receive broadcast control information and system information blocks from the second downlink carrier. The wireless device may transmit second control data over a second physical uplink control channel on a second uplink carrier as shown in task 814. The second uplink carrier corresponds to the second downlink carrier. The second control data may comprise at least one of: a) positive and negative acknowledgements for some of data packets received, b) channel state information for the second downlink carrier, c) scheduling request, and/or a combination of the above.

The at least one control message may be received when a load of the first uplink carrier and the second uplink carrier are substantially different. The load may be determined using different methods. For example, the load may be the load of uplink control channel. The load may be the number of wireless devices with a given downlink carrier as their primary carrier. The at least one control message may be received when a load of the first downlink carrier and the second downlink carrier are substantially different. The load may be the load of downlink control channel. The load may be the number of wireless devices with certain downlink carrier as their primary carrier. The at least one control message may be received from the base station, if a signal quality of the second downlink carrier is above the signal quality of the first downlink carrier by a threshold margin. The threshold margin may be equal or greater than zero. In an example implementation, the first uplink carrier and the second uplink carrier may be the same carrier or different carriers.

According to some of the various aspects of embodiments, a wireless device may receive data traffic using carrier aggregation from a base station. The wireless device and/or the base station may be configured to communicate employing a plurality of downlink carriers and a plurality of uplink carriers. The wireless device may receive a plurality of data packets on a first downlink carrier and a second downlink carrier from the base station. The wireless device may receive broadcast control information from the first downlink carrier. The wireless may receive the broadcast system information blocks from the first downlink carrier and not from the second downlink carrier. The wireless device may transmit a first control data over a first physical uplink control channel on a first uplink carrier. The first uplink carrier corresponds to the first downlink carrier. The first physical uplink control channel may comprise at least one of: a) positive and negative acknowledgements for data packets received on the first downlink carrier and the second downlink carrier, b) channel state information for the first downlink carrier and the second downlink carrier, c) a scheduling request, and/or a combination of the above.

The wireless device may receive at least one control message from the base station. The at least one control message may reconfigure the configuration of the first downlink carrier and the second downlink carrier of the wireless device. In an example, the first carrier may be released. The wireless device may receive a plurality of data packets on the second downlink carrier from the base station. The second downlink carrier carries the broadcast control information for the wireless device. The wireless device may receive broadcast control information from the second downlink carrier. The wireless may receive the broadcast system information blocks from the second downlink carrier and not from the first downlink carrier. The wireless device may transmit second control data over a second physical uplink control channel on a second uplink carrier. The second uplink carrier corresponds to the second downlink carrier. The second control data may comprise at least one of: a) positive and negative acknowledgements for some of data packets received on the second downlink carrier, b) channel state information for the second downlink carrier, c) scheduling request, and/or a combination of the above.

According to some of the various aspects of embodiments, RRC connection establishment may involve the establishment of signaling radio bearer 1 (SRB1). An LTE wireless network may complete RRC connection establishment prior to completing the establishment of the S1 connection, e.g. prior to receiving the wireless device context information from the EPC. Consequently, access stratum security may not be activated during the initial phase of the RRC connection. During this initial phase of the RRC connection, the wireless network may configure the wireless device to perform measurement reporting. The wireless device may accept a handover message when security has been activated.

The purpose of RRC connection establishment procedure may be to establish an RRC connection. RRC connection establishment may involve SRB1 establishment. The procedure may be used to transfer the initial non-access stratum dedicated information/message from the wireless device to wireless network. Wireless network may apply the procedure to establish SRB1. The wireless device may initiate the procedure when upper layers request establishment of an RRC connection while the wireless device is in RRC-idle state. When the wireless device is in idle state and needs to transmit a non-access stratum message, it may request the lower layer to establish a signaling connection. During the signaling connection, the wireless device may provide the establishment cause to RRC. Signaling radio bearer 0 (SRB0) is used for sending the RRC connection request message on uplink common control channel. The wireless device may transmit an RRC connection request to the base station, and base station may respond by transmitting the RRC connection set up message to the wireless device. After the wireless device receives the RRC connection setup message, it may transmit an RRC connection setup complete message back to the base station.

According to some of the various aspects of embodiments, in the RRC connection setup message, the base station may configure the RLC and logical channel for SRB1. Base station may comprise MAC and PHY configuration in RRC connection set up message. The base station may not have any information about the wireless device capability at this point in time. It is likely that the base station configures the RRC connection with minimum configuration that all or most wireless devices are likely to support. Once the wireless device receives RRC connection setup, the wireless device and base station may use the SRB1 to exchange signaling messages. Once the SRB1 is established, the wireless device may send non-access stratum information to the wireless network. The wireless device may transmit the selected PLMN ID and/or the registered MME.

After connection set up complete message, the initial security activation process may start. Upon receiving the wireless device context from the EPC, wireless network may activate security (both ciphering and integrity protection) using the initial security activation procedure. This procedure may activate access stratum security upon RRC connection establishment. Wireless network may initiate the security mode command procedure to a wireless device in RRC-Connected mode. Moreover, wireless network may apply the procedure when only SRB1 (signaling radio bearer 1) is established, e.g. prior to establishment of SRB2 (signaling radio bearer 2) and/or Data radio bearers (DRBs). The RRC messages to activate security (command and successful response) may be integrity protected, while ciphering may start after completion of the procedure. That is, the response to the message used to activate security may not be ciphered, while the subsequent messages (e.g. used to establish SRB2 and DRBs) may be both integrity protected and ciphered.

Wireless device capability transfer procedure may transfer wireless device radio access capability information to wireless network. If the wireless device has changed its wireless network radio access capabilities, the wireless device may request higher layers to initiate the necessary non-access stratum procedures that may result in the update of wireless device radio access capabilities using a new RRC connection. Wireless network may initiate the procedure to a wireless device in RRC-connected when it needs (additional) wireless device radio access capability information. The base station may send a capability inquiry to receive the radio access capability information of the wireless device. The base station may indicate the radio access technology for which it is requesting the capabilities, such as E-UTRAN, UTRAN, GERAN, and CDMA. The wireless device may respond with capability information message, which comprise the requested capabilities for example: wireless device category, PDCP capabilities (such as ROHC support and profiles), PHY capabilities (such as Tx and Rx antenna configurations), RF parameters (such as supported band list), and inter-RAT parameters. The information obtained may be used to set up the MAC and PHY configuration of the connection. It may enable efficient measurement control, preventing unnecessary waking up of the measurement entity.

After having initiated the initial security activation procedure, wireless network may initiate the establishment of SRB2 and data radio bearers (DRB), e.g. wireless network may do this prior to receiving the confirmation of the initial security activation from the wireless device. Wireless network may apply both ciphering and integrity protection for the RRC connection reconfiguration messages used to establish SRB2 and DRBs. Wireless network may release the RRC connection if the initial security activation and/or the radio bearer establishment fails (e.g. security activation and DRB establishment may be triggered by a joint S1-procedure, which does not support partial success). The wireless device may respond with the RRC connection reconfiguration on SRB1 to acknowledge the first RRC connection reconfiguration message to acknowledge the establishment of SRB2 and DRB. The base station may configure the measurement configuration at the wireless device for connected mode measurement and reporting using the RRC connection reconfiguration message.

For SRB2 and DRBs, security may be activated from the start, e.g. the wireless network may not establish these bearers prior to activating security. After having initiated the initial security activation procedure, wireless network may configure a wireless device that supports carrier aggregation, with one or more secondary cells in addition to the primary cell that was initially configured during connection establishment. The primary cell may be used to provide the security inputs and upper layer system information (e.g. the non-access stratum mobility information e.g. TAI). Secondary cells may be used to provide additional downlink and optionally uplink radio resources. For some of the secondary carriers, the base station needs to receive at least one measurement report and add the secondary carrier satisfies the required signal quality.

RRC connection reconfiguration may modify an RRC connection, e.g. to establish/modify/release RBs, to perform handover, to setup/modify/release measurements, to add/modify/release secondary cells. As part of the procedure, non-access stratum dedicated information may be transferred from wireless network to the wireless device.

Wireless network may initiate the RRC connection reconfiguration procedure to a wireless device in RRC-connected mode. Wireless network may apply the procedure for the establishment of RBs (other than SRB1, that is established during RRC connection establishment) when access stratum security has been activated. The addition of secondary cells may be performed when access stratum security has been activated;

The wireless device may report measurement information in accordance with the measurement configuration as provided by wireless network. Wireless network may provide the measurement configuration applicable for a wireless device in RRC-connected by means of dedicated signaling, e.g. using the RRC Connection Reconfiguration message. The wireless device may be requested to perform the following types of measurements: a) intra-frequency measurements: measurements at the downlink carrier frequency(ies) of the serving cell(s), b) inter-frequency measurements: measurements at frequencies that differ from any of the downlink carrier frequency(ies) of the serving cell(s), c) inter-RAT measurements of UTRA frequencies, d) inter-RAT measurements of GERAN frequencies, e) inter-RAT measurements of CDMA2000 HRPD or CDMA2000 1xRTT frequencies. The measurement configuration may include: measurement objects, reporting configurations, measurement identities, quantity configurations, and/or measurement gaps.

Measurement objects are the objects on which the wireless device may perform the measurements. For intra-frequency and inter-frequency measurements a measurement object may be a single E-UTRA carrier frequency. Associated with this carrier frequency, wireless network may configure a list of cell specific offsets and a list of ‘blacklisted’ cells. Blacklisted cells may not be considered in event evaluation or measurement reporting. For inter-RAT UTRA measurements a measurement object may be a set of cells on a single UTRA carrier frequency. For inter-RAT GERAN measurements a measurement object may be a set of GERAN carrier frequencies. For inter-RAT CDMA2000 measurements a measurement object may be a set of cells on a single (HRPD or 1xRTT) carrier frequency.

Reporting configurations may comprise a list of reporting configurations where each reporting configuration may comprise reporting criterion and/or reporting format. Reporting criterion may be the criterion that triggers the wireless device to send a measurement report. This may either be periodical or a single event description. Reporting format may be the quantities that the wireless device comprises in the measurement report and associated information (e.g. number of cells to report).

Measurement identities may comprise a list of measurement identities where each measurement identity links one measurement object with one reporting configuration. By configuring multiple measurement identities it may be possible to link more than one measurement object to the same reporting configuration, as well as to link more than one reporting configuration to the same measurement object. The measurement identity may be used as a reference number in the measurement report. One quantity configuration may be configured per RAT (radio access technology) type. The quantity configuration may define the measurement quantities and associated filtering used for all event evaluation and related reporting of that measurement type. One filter may be configured per measurement quantity. Measurement gaps may be periods that the wireless device may use to perform measurements, e.g. no (UL, DL) transmissions are scheduled.

Wireless network may configure a single measurement object for a given frequency, e.g. it may not configure two or more measurement objects for the same frequency with different associated parameters, e.g. different offsets and/or blacklists Wireless network may configure multiple instances of the same event e.g. by configuring two reporting configurations with different thresholds. The wireless device may maintain a single measurement object list, a single reporting configuration list, and a single measurement identities list. The measurement object list may comprise measurement objects, that are specified per RAT type, possibly comprising intra-frequency object(s) (for example, the object(s) corresponding to the serving frequency(ies)), inter-frequency object(s) and inter-RAT objects. Similarly, the reporting configuration list may comprise E-UTRA and inter-RAT reporting configurations. Any measurement object can be linked to any reporting configuration of the same RAT type. Some reporting configurations may not be linked to a measurement object. Likewise, some measurement objects may not be linked to a reporting configuration.

The measurement procedures may distinguish the following types of cells: The serving cell(s), Listed cells, Detected cells. The serving cell(s) may be the primary cell and one or more secondary cells, if configured for a wireless device supporting carrier aggregation. Listed cells may be cells listed within the measurement object(s). Detected cells may be cells that are not listed within the measurement object(s) but are detected by the wireless device on the carrier frequency(ies) indicated by the measurement object(s). For E-UTRA, the wireless device may measure and report on the serving cell(s), listed cells and detected cells. For inter-RAT UTRA, the wireless device may measure and report on listed cells and optionally on cells that are within a range for which reporting is allowed by wireless network. For inter-RAT GERAN, the wireless device may measure and report on detected cells. For inter-RAT CDMA2000, the wireless device may measure and reports on listed cells.

After the base station receives at least one measurement report, the base station may configure additional secondary carriers. This may be done if the additional secondary carriers signal qualities are acceptable. In order to transmit traffic on deactivated secondary carriers, the base station may transmit an activation command to the wireless device in order to activate the secondary carriers. Then the base station may transmit data and control packets on the activated secondary carriers.

The example embodiments are different from current soft handover methods implemented in various technologies. In soft handover, multiple carriers have the same frequency and may transmit the same data traffic to the wireless device. In example embodiments different carriers carry different streams of data traffic to increase the transmission bit rate. In a scenario, in which a new carrier is added to an existing base station, different carriers have different carrier frequencies. In the handover scenario in an example embodiment, a new carrier from a target base station is added to increase transmission bit rate of the target base station.

In carrier aggregation (CA), two or more carriers may be aggregated in order to support wider transmission bandwidths. A wireless device may simultaneously receive or transmit on one or multiple carriers depending on its capabilities. An LTE Rel-10 or beyond wireless device with reception and/or transmission capabilities for CA may simultaneously receive and/or transmit on multiple carriers corresponding to multiple serving cells belonging to the same or different transmitters. An LTE Rel-8/9 wireless device may receive on a single carrier and transmit on a single carrier corresponding to one serving cell only.

CA may be supported for both contiguous and non-contiguous carriers with each carrier being limited to a maximum of 110 Resource Blocks in the frequency domain using the Rel-8/9 numerology. It is possible to configure a wireless device to aggregate a different number of carriers originating from the same base station and of possibly different bandwidths in the uplink and the downlink. The number of downlink carriers that may be configured depends on the downlink aggregation capability of the wireless device. The number of uplink carriers that may be configured depends on the uplink aggregation capability of the wireless device. It may not possible to configure a wireless device with more uplink carriers than downlink carriers. In typical TDD deployments, the number of carriers and the bandwidth of each carrier in uplink and downlink is the same. Carriers originating from the same base station may not provide the same coverage.

Carriers may be LTE Rel-8/9 compatible, in some implementation some of the carriers may not be LTE Rel-8/9 compatible. The spacing between center frequencies of contiguously aggregated carriers may be a multiple of 300 kHz. This is in order to be compatible with the 100 kHz frequency raster of Rel-8/9 and at the same time preserve orthogonality of the subcarriers with 15 kHz spacing. Depending on the aggregation scenario, the n×300 kHz spacing may be facilitated by insertion of a low number of unused subcarriers between contiguous CCs.

When CA is configured, the wireless device may have one RRC connection with the network. At RRC connection establishment/re-establishment/handover, one serving cell may provide the NAS mobility information (e.g. TAI), and at RRC connection re-establishment/handover, one serving cell may provide the security input. This cell may be referred to as a primary cell. In the downlink, the carrier corresponding to the primary cell is the downlink primary carrier while in the uplink it is the uplink primary carrier.

Depending on wireless device capabilities, secondary cells may be configured to form together with the primary cell a set of serving cells. In the downlink, the carrier corresponding to a secondary cell is a downlink secondary carrier while in the uplink it is an uplink secondary carrier. The configured set of serving cells for a wireless device therefore may comprise of one primary cell and one or more secondary cells. For each secondary cell the usage of uplink resources by the wireless device in addition to the downlink ones may be configurable. The number of downlink secondary carriers configured is therefore always larger than or equal to the number of uplink secondary carriers and no secondary cell may be configured for usage of uplink resources only.

From a wireless device viewpoint, each uplink resource may belong to one serving cell. The number of serving cells that may be configured depends on the aggregation capability of the wireless device. Primary cell may be changed with handover procedure (e.g. with security key change and RACH procedure). Primary cell may be used for transmission of PUCCH. Unlike secondary cells, primary cell may not be de-activated. Re-establishment may be triggered when primary cell experiences radio link failure, and not when secondary cells experience radio link failure. NAS information may be taken from primary cell.

The reconfiguration, addition and removal of secondary cells may be performed by RRC. At intra-LTE handover, RRC may add, remove, or reconfigure secondary cells for usage with the target primary cell. When adding a new secondary cell, dedicated RRC signaling may be used for sending required system information of the secondary cell, e.g. while in connected mode, wireless devices may not acquire broadcasted system information directly from the secondary cells.

In example embodiments, RRC control messages or control packets may be scheduled for transmission in the physical downlink shared channel (PDSCH). PDSCH may carry control and data messages/packets. Control messages or packets may be processed before transmission, for example they may be fragmented or multiplexed before transmission. A control message in the upper layer may be processed as a data packet in the MAC or physical layer. For example, system information blocks as well as data traffic are scheduled for transmission in PDSCH. The data packets may be encrypted packets. Data packets may be encrypted before transmission to secure the packets from unwanted receivers. The desired recipient may be able to decrypt the packets. The data packets may be encrypted using an encryption key and at least one parameter that changes substantially rapidly over time. This encryption mechanism provides a transmission that may not be easily eavesdropped by unwanted receivers. Comprising additional parameters in encryption module that changes substantially rapidly in time enhances the security mechanism. An example varying parameter may be any types of system counter. The encryption may be provided by the PDCP layer between the transmitter and receiver. Additional overhead added to the packets by the lower layers such as RLC, MAC, and Physical layer may not be encrypted before transmission.

In the wireless device, the plurality of encrypted data packets may be decrypted using a first decryption key and at least one first parameter. The plurality of data packets may be decrypted using an additional parameter that changes substantially rapidly over time.

The wireless device may be preconfigured with one or more carriers. When the transmitter may be a base station configured with more than one carrier, the base station may activate and deactivate the configured carriers. One of the carriers (the primary carrier) may always be activated, but other carriers may be deactivated or activated by base station when needed. The base station may activate and deactivate carriers by sending the activation/deactivation MAC control element or using RRC reconfiguration command. Furthermore, the wireless device may maintain a carrier deactivation timer per configured carrier and deactivate the associated carrier upon its expiry. The same initial timer value applies to each instance of the carrier deactivation timer and the initial value of the timer is configured by the network. The configured carriers (unless the primary carrier) may be initially deactivated upon addition and after a handover. In another example embodiment, the configured carriers may be initially activated upon addition and after a handover.

In an example embodiment, if a wireless device receives an activation/deactivation MAC control element or an RRC message activating the carrier, the wireless device may activate the carrier, and may apply normal carrier operation comprising: sounding reference signal transmissions on the carrier, CQI/PMI/RI reporting for the carrier, PDCCH monitoring on the carrier, PDCCH monitoring for the carrier, start or restart the carrier deactivation timer associated with the carrier. If the wireless device receives an activation/deactivation MAC control element deactivating the carrier, or if the carrier deactivation timer associated with the activated carrier expires, the base station or wireless device may deactivate the carrier, and may stop the carrier deactivation timer associated with the carrier, and may flush all HARQ buffers associated with the carrier.

If PDCCH on a carrier scheduling the activated carrier indicates an uplink grant or a downlink assignment for the activated carrier, then the wireless device may restart the carrier deactivation timer associated with the carrier. When a carrier is deactivated, the wireless device may not transmit SRS for the carrier, may not report CQI/PMI/RI for the carrier, may not transmit on UL-SCH for the carrier, may not monitor the PDCCH on the carrier, and may not monitor the PDCCH for the carrier.

According to some of the various aspects of embodiments, the packets in the downlink may be transmitted via downlink physical channels. The carrying packets in the uplink may be transmitted via uplink physical channels. The baseband data representing a downlink physical channel may be defined in terms of at least one of the following actions: scrambling of coded bits in codewords to be transmitted on a physical channel; modulation of scrambled bits to generate complex-valued modulation symbols; mapping of the complex-valued modulation symbols onto one or several transmission layers; precoding of the complex-valued modulation symbols on layer(s) for transmission on the antenna port(s); mapping of complex-valued modulation symbols for antenna port(s) to resource elements; and/or generation of complex-valued time-domain OFDM signal(s) for antenna port(s).

Codeword, transmitted on the physical channel in one subframe, may be scrambled prior to modulation, resulting in a block of scrambled bits. The scrambling sequence generator may be initialized at the start of subframe(s). Codeword(s) may be modulated using QPSK, 16QAM, 64QAM, 128QAM, and/or the like resulting in a block of complex-valued modulation symbols. The complex-valued modulation symbols for codewords to be transmitted may be mapped onto one or several layers. For transmission on a single antenna port, a single layer may be used. For spatial multiplexing, the number of layers may be less than or equal to the number of antenna port(s) used for transmission of the physical channel. The case of a single codeword mapped to multiple layers may be applicable when the number of cell-specific reference signals is four or when the number of UE-specific reference signals is two or larger. For transmit diversity, there may be one codeword and the number of layers may be equal to the number of antenna port(s) used for transmission of the physical channel.

The precoder may receive a block of vectors from the layer mapping and generate a block of vectors to be mapped onto resources on the antenna port(s). Precoding for spatial multiplexing using antenna port(s) with cell-specific reference signals may be used in combination with layer mapping for spatial multiplexing. Spatial multiplexing may support two or four antenna ports and the set of antenna ports used may be {0, 1} or {0, 1, 2, 3}. Precoding for transmit diversity may be used in combination with layer mapping for transmit diversity. The precoding operation for transmit diversity may be defined for two and four antenna ports. Precoding for spatial multiplexing using antenna ports with UE-specific reference signals may also, for example, be used in combination with layer mapping for spatial multiplexing. Spatial multiplexing using antenna ports with UE-specific reference signals may support up to eight antenna ports. Reference signals may be pre-defined signals that may be used by the receiver for decoding the received physical signal, estimating the channel state, and/or other purposes.

For antenna port(s) used for transmission of the physical channel, the block of complex-valued symbols may be mapped in sequence to resource elements. In resource blocks in which UE-specific reference signals are not transmitted the PDSCH may be transmitted on the same set of antenna ports as the physical broadcast channel in the downlink (PBCH). In resource blocks in which UE-specific reference signals are transmitted, the PDSCH may be transmitted, for example, on antenna port(s) {5, {7}, {8}, or {7, 8, . . . , v+6}, where v is the number of layers used for transmission of the PDSCH.

Common reference signal(s) may be transmitted in physical antenna port(s). Common reference signal(s) may be cell-specific reference signal(s) (RS) used for demodulation and/or measurement purposes. Channel estimation accuracy using common reference signal(s) may be reasonable for demodulation (high RS density). Common reference signal(s) may be defined for LTE technologies, LTE-advanced technologies, and/or the like. Demodulation reference signal(s) may be transmitted in virtual antenna port(s) (i.e., layer or stream). Channel estimation accuracy using demodulation reference signal(s) may be reasonable within allocated time/frequency resources. Demodulation reference signal(s) may be defined for LTE-advanced technology and may not be applicable to LTE technology. Measurement reference signal(s), may also called CSI (channel state information) reference signal(s), may be transmitted in physical antenna port(s) or virtualized antenna port(s). Measurement reference signal(s) may be Cell-specific RS used for measurement purposes. Channel estimation accuracy may be relatively lower than demodulation RS. CSI reference signal(s) may be defined for LTE-advanced technology and may not be applicable to LTE technology.

In at least one of the various embodiments, uplink physical channel(s) may correspond to a set of resource elements carrying information originating from higher layers. The following example uplink physical channel(s) may be defined for uplink: a) Physical Uplink Shared Channel (PUSCH), b) Physical Uplink Control Channel (PUCCH), c) Physical Random Access Channel (PRACH), and/or the like. Uplink physical signal(s) may be used by the physical layer and may not carry information originating from higher layers. For example, reference signal(s) may be considered as uplink physical signal(s). Transmitted signal(s) in slot(s) may be described by one or several resource grids including, for example, subcarriers and SC-FDMA or OFDMA symbols. Antenna port(s) may be defined such that the channel over which symbol(s) on antenna port(s) may be conveyed and/or inferred from the channel over which other symbol(s) on the same antenna port(s) is/are conveyed. There may be one resource grid per antenna port. The antenna port(s) used for transmission of physical channel(s) or signal(s) may depend on the number of antenna port(s) configured for the physical channel(s) or signal(s).

Element(s) in a resource grid may be called a resource element. A physical resource block may be defined as N consecutive SC-FDMA symbols in the time domain and/or M consecutive subcarriers in the frequency domain, wherein M and N may be pre-defined integer values. Physical resource block(s) in uplink(s) may comprise of M×N resource elements. For example, a physical resource block may correspond to one slot in the time domain and 180 kHz in the frequency domain. Baseband signal(s) representing the physical uplink shared channel may be defined in terms of: a) scrambling, b) modulation of scrambled bits to generate complex-valued symbols, c) mapping of complex-valued modulation symbols onto one or several transmission layers, d) transform precoding to generate complex-valued symbols, e) precoding of complex-valued symbols, f) mapping of precoded complex-valued symbols to resource elements, g) generation of complex-valued time-domain SC-FDMA signal(s) for antenna port(s), and/or the like.

For codeword(s), block(s) of bits may be scrambled with UE-specific scrambling sequence(s) prior to modulation, resulting in block(s) of scrambled bits. Complex-valued modulation symbols for codeword(s) to be transmitted may be mapped onto one, two, or more layers. For spatial multiplexing, layer mapping(s) may be performed according to pre-defined formula (s). The number of layers may be less than or equal to the number of antenna port(s) used for transmission of physical uplink shared channel(s). The example of a single codeword mapped to multiple layers may be applicable when the number of antenna port(s) used for PUSCH is, for example, four. For layer(s), the block of complex-valued symbols may be divided into multiple sets, each corresponding to one SC-FDMA symbol. Transform precoding may be applied. For antenna port(s) used for transmission of the PUSCH in a subframe, block(s) of complex-valued symbols may be multiplied with an amplitude scaling factor in order to conform to a required transmit power, and mapped in sequence to physical resource block(s) on antenna port(s) and assigned for transmission of PUSCH.

According to some of the various embodiments, data may arrive to the coding unit in the form of two transport blocks every transmission time interval (TTI) per UL cell. The following coding actions may be identified for transport block(s) of an uplink carrier: a) Add CRC to the transport block, b) Code block segmentation and code block CRC attachment, c) Channel coding of data and control information, d) Rate matching, e) Code block concatenation, f) Multiplexing of data and control information, g) Channel interleaver, h) Error detection may be provided on UL-SCH (uplink shared channel) transport block(s) through a Cyclic Redundancy Check (CRC), and/or the like. Transport block(s) may be used to calculate CRC parity bits. Code block(s) may be delivered to channel coding block(s). Code block(s) may be individually turbo encoded. Turbo coded block(s) may be delivered to rate matching block(s).

Physical uplink control channel(s) (PUCCH) may carry uplink control information. Simultaneous transmission of PUCCH and PUSCH from the same UE may be supported if enabled by higher layers. For a type 2 frame structure, the PUCCH may not be transmitted in the UpPTS field. PUCCH may use one resource block in each of the two slots in a subframe. Resources allocated to UE and PUCCH configuration(s) may be transmitted via control messages. PUCCH may comprise: a) positive and negative acknowledgements for data packets transmitted at least one downlink carrier, b) channel state information for at least one downlink carrier, c) scheduling request, and/or the like.

According to some of the various aspects of embodiments, cell search may be the procedure by which a wireless device may acquire time and frequency synchronization with a cell and may detect the physical layer Cell ID of that cell (transmitter). An example embodiment for synchronization signal and cell search is presented below. A cell search may support a scalable overall transmission bandwidth corresponding to 6 resource blocks and upwards. Primary and secondary synchronization signals may be transmitted in the downlink and may facilitate cell search. For example, 504 unique physical-layer cell identities may be defined using synchronization signals. The physical-layer cell identities may be grouped into 168 unique physical-layer cell-identity groups, group(s) containing three unique identities. The grouping may be such that physical-layer cell identit(ies) is part of a physical-layer cell-identity group. A physical-layer cell identity may be defined by a number in the range of 0 to 167, representing the physical-layer cell-identity group, and a number in the range of 0 to 2, representing the physical-layer identity within the physical-layer cell-identity group. The synchronization signal may include a primary synchronization signal and a secondary synchronization signal.

According to some of the various aspects of embodiments, the sequence used for a primary synchronization signal may be generated from a frequency-domain Zadoff-Chu sequence according to a pre-defined formula. A Zadoff-Chu root sequence index may also be predefined in a specification. The mapping of the sequence to resource elements may depend on a frame structure. The wireless device may not assume that the primary synchronization signal is transmitted on the same antenna port as any of the downlink reference signals. The wireless device may not assume that any transmission instance of the primary synchronization signal is transmitted on the same antenna port, or ports, used for any other transmission instance of the primary synchronization signal. The sequence may be mapped to the resource elements according to a predefined formula.

For FDD frame structure, a primary synchronization signal may be mapped to the last OFDM symbol in slots 0 and 10. For TDD frame structure, the primary synchronization signal may be mapped to the third OFDM symbol in subframes 1 and 6. Some of the resource elements allocated to primary or secondary synchronization signals may be reserved and not used for transmission of the primary synchronization signal.

According to some of the various aspects of embodiments, the sequence used for a secondary synchronization signal may be an interleaved concatenation of two length-31 binary sequences. The concatenated sequence may be scrambled with a scrambling sequence given by a primary synchronization signal. The combination of two length-31 sequences defining the secondary synchronization signal may differ between subframe 0 and subframe 5 according to predefined formula (s). The mapping of the sequence to resource elements may depend on the frame structure. In a subframe for FDD frame structure and in a half-frame for TDD frame structure, the same antenna port as for the primary synchronization signal may be used for the secondary synchronization signal. The sequence may be mapped to resource elements according to a predefined formula.

Example embodiments for the physical channels configuration will now be presented. Other examples may also be possible. A physical broadcast channel may be scrambled with a cell-specific sequence prior to modulation, resulting in a block of scrambled bits. PBCH may be modulated using QPSK, and/or the like. The block of complex-valued symbols for antenna port(s) may be transmitted during consecutive radio frames, for example, four consecutive radio frames. In some embodiments the PBCH data may arrive to the coding unit in the form of a one transport block every transmission time interval (TTI) of 40 ms. The following coding actions may be identified. Add CRC to the transport block, channel coding, and rate matching. Error detection may be provided on PBCH transport blocks through a Cyclic Redundancy Check (CRC). The transport block may be used to calculate the CRC parity bits. The parity bits may be computed and attached to the BCH (broadcast channel) transport block. After the attachment, the CRC bits may be scrambled according to the transmitter transmit antenna configuration. Information bits may be delivered to the channel coding block and they may be tail biting convolutionally encoded. A tail biting convolutionally coded block may be delivered to the rate matching block. The coded block may be rate matched before transmission.

A master information block may be transmitted in PBCH and may include system information transmitted on broadcast channel(s). The master information block may include downlink bandwidth, system frame number(s), and PHICH (physical hybrid-ARQ indicator channel) configuration. Downlink bandwidth may be the transmission bandwidth configuration, in terms of resource blocks in a downlink, for example 6 may correspond to 6 resource blocks, 15 may correspond to 15 resource blocks and so on. System frame number(s) may define the N (for example N=8) most significant bits of the system frame number. The M (for example M=2) least significant bits of the SFN may be acquired implicitly in the PBCH decoding. For example, timing of a 40 ms PBCH TTI may indicate 2 least significant bits (within 40 ms PBCH TTI, the first radio frame: 00, the second radio frame: 01, the third radio frame: 10, the last radio frame: 11). One value may apply for other carriers in the same sector of a base station (the associated functionality is common (e.g. not performed independently for each cell). PHICH configuration(s) may include PHICH duration, which may be normal (e.g. one symbol duration) or extended (e.g. 3 symbol duration).

Physical control format indicator channel(s) (PCFICH) may carry information about the number of OFDM symbols used for transmission of PDCCHs (physical downlink control channel) in a subframe. The set of OFDM symbols possible to use for PDCCH in a subframe may depend on many parameters including, for example, downlink carrier bandwidth, in terms of downlink resource blocks. PCFICH transmitted in one subframe may be scrambled with cell-specific sequence(s) prior to modulation, resulting in a block of scrambled bits. A scrambling sequence generator(s) may be initialized at the start of subframe(s). Block (s) of scrambled bits may be modulated using QPSK. Block(s) of modulation symbols may be mapped to at least one layer and precoded resulting in a block of vectors representing the signal for at least one antenna port. Instances of PCFICH control channel(s) may indicate one of several (e.g. 3) possible values after being decoded. The range of possible values of instance(s) of the first control channel may depend on the first carrier bandwidth.

According to some of the various embodiments, physical downlink control channel(s) may carry scheduling assignments and other control information. The number of resource-elements not assigned to PCFICH or PHICH may be assigned to PDCCH. PDCCH may support multiple formats. Multiple PDCCH packets may be transmitted in a subframe. PDCCH may be coded by tail biting convolutionally encoder before transmission. PDCCH bits may be scrambled with a cell-specific sequence prior to modulation, resulting in block(s) of scrambled bits. Scrambling sequence generator(s) may be initialized at the start of subframe(s). Block(s) of scrambled bits may be modulated using QPSK. Block(s) of modulation symbols may be mapped to at least one layer and precoded resulting in a block of vectors representing the signal for at least one antenna port. PDCCH may be transmitted on the same set of antenna ports as the PBCH, wherein PBCH is a physical broadcast channel broadcasting at least one basic system information field.

According to some of the various embodiments, scheduling control packet(s) may be transmitted for packet(s) or group(s) of packets transmitted in downlink shared channel(s). Scheduling control packet(s) may include information about subcarriers used for packet transmission(s). PDCCH may also provide power control commands for uplink channels. OFDM subcarriers that are allocated for transmission of PDCCH may occupy the bandwidth of downlink carrier(s). PDCCH channel(s) may carry a plurality of downlink control packets in subframe(s). PDCCH may be transmitted on downlink carrier(s) starting from the first OFDM symbol of subframe(s), and may occupy up to multiple symbol duration(s) (e.g. 3 or 4).

According to some of the various embodiments, PHICH may carry the hybrid-ARQ (automatic repeat request) ACK/NACK. Multiple PHICHs mapped to the same set of resource elements may constitute a PHICH group, where PHICHs within the same PHICH group may be separated through different orthogonal sequences. PHICH resource(s) may be identified by the index pair (group, sequence), where group(s) may be the PHICH group number(s) and sequence(s) may be the orthogonal sequence index within the group(s). For frame structure type 1, the number of PHICH groups may depend on parameters from higher layers (RRC). For frame structure type 2, the number of PHICH groups may vary between downlink subframes according to a pre-defined arrangement. Block(s) of bits transmitted on one PHICH in one subframe may be modulated using BPSK or QPSK, resulting in a block(s) of complex-valued modulation symbols. Block(s) of modulation symbols may be symbol-wise multiplied with an orthogonal sequence and scrambled, resulting in a sequence of modulation symbols

Other arrangements for PCFICH, PHICH, PDCCH, and/or PDSCH may be supported. The configurations presented here are for example purposes. In another example, resources PCFICH, PHICH, and/or PDCCH radio resources may be transmitted in radio resources including a subset of subcarriers and pre-defined time duration in each or some of the subframes. In an example, PUSCH resource(s) may start from the first symbol. In another example embodiment, radio resource configuration(s) for PUSCH, PUCCH, and/or PRACH (physical random access channel) may use a different configuration. For example, channels may be time multiplexed, or time/frequency multiplexed when mapped to uplink radio resources.

According to some of the various aspects of embodiments, the physical layer random access preamble may comprise a cyclic prefix of length Tcp and a sequence part of length Tseq. The parameter values may be pre-defined and depend on the frame structure and a random access configuration. In an example embodiment, Tcp may be 0.1 msec, and Tseq may be 0.9 msec. Higher layers may control the preamble format. The transmission of a random access preamble, if triggered by the MAC layer, may be restricted to certain time and frequency resources. The start of a random access preamble may be aligned with the start of the corresponding uplink subframe at a wireless device.

According to an example embodiment, random access preambles may be generated from Zadoff-Chu sequences with a zero correlation zone, generated from one or several root Zadoff-Chu sequences. In another example embodiment, the preambles may also be generated using other random sequences such as Gold sequences. The network may configure the set of preamble sequences a wireless device may be allowed to use. According to some of the various aspects of embodiments, there may be a multitude of preambles (e.g. 64) available in cell(s). From the physical layer perspective, the physical layer random access procedure may include the transmission of random access preamble(s) and random access response(s). Remaining message(s) may be scheduled for transmission by a higher layer on the shared data channel and may not be considered part of the physical layer random access procedure. For example, a random access channel may occupy 6 resource blocks in a subframe or set of consecutive subframes reserved for random access preamble transmissions.

According to some of the various embodiments, the following actions may be followed for a physical random access procedure: 1) layer 1 procedure may be triggered upon request of a preamble transmission by higher layers; 2) a preamble index, a target preamble received power, a corresponding RA-RNTI (random access-radio network temporary identifier) and/or a PRACH resource may be indicated by higher layers as part of a request; 3) a preamble transmission power P_PRACH may be determined; 4) a preamble sequence may be selected from the preamble sequence set using the preamble index; 5) a single preamble may be transmitted using selected preamble sequence(s) with transmission power P_PRACH on the indicated PRACH resource; 6) detection of a PDCCH with the indicated RAR may be attempted during a window controlled by higher layers; and/or the like. If detected, the corresponding downlink shared channel transport block may be passed to higher layers. The higher layers may parse transport block(s) and/or indicate an uplink grant to the physical layer(s).

According to some of the various aspects of embodiments, a random access procedure may be initiated by a physical downlink control channel (PDCCH) order and/or by the MAC sublayer in a wireless device. If a wireless device receives a PDCCH transmission consistent with a PDCCH order masked with its radio identifier, the wireless device may initiate a random access procedure. Preamble transmission(s) on physical random access channel(s) (PRACH) may be supported on a first uplink carrier and reception of a PDCCH order may be supported on a first downlink carrier.

Before a wireless device initiates transmission of a random access preamble, it may access one or many of the following types of information: a) available set(s) of PRACH resources for the transmission of a random access preamble; b) group(s) of random access preambles and set(s) of available random access preambles in group(s); c) random access response window size(s); d) power-ramping factor(s); e) maximum number(s) of preamble transmission(s); f) initial preamble power; g) preamble format based offset(s); h) contention resolution timer(s); and/or the like. These parameters may be updated from upper layers or may be received from the base station before random access procedure(s) may be initiated.

According to some of the various aspects of embodiments, a wireless device may select a random access preamble using available information. The preamble may be signaled by a base station or the preamble may be randomly selected by the wireless device. The wireless device may determine the next available subframe containing PRACH permitted by restrictions given by the base station and the physical layer timing requirements for TDD or FDD. Subframe timing and the timing of transmitting the random access preamble may be determined based, at least in part, on synchronization signals received from the base station and/or the information received from the base station. The wireless device may proceed to the transmission of the random access preamble when it has determined the timing. The random access preamble may be transmitted on a second plurality of subcarriers on the first uplink carrier.

According to some of the various aspects of embodiments, once a random access preamble is transmitted, a wireless device may monitor the PDCCH of a first downlink carrier for random access response(s), in a random access response window. There may be a pre-known identifier in PDCCH that indentifies a random access response. The wireless device may stop monitoring for random access response(s) after successful reception of a random access response containing random access preamble identifiers that matches the transmitted random access preamble and/or a random access response address to a wireless device identifier. A base station random access response may include a time alignment command. The wireless device may process the received time alignment command and may adjust its uplink transmission timing according the time alignment value in the command. For example, in a random access response, a time alignment command may be coded using 11 bits, where an amount of the time alignment may be based on the value in the command. In an example embodiment, when an uplink transmission is required, the base station may provide the wireless device a grant for uplink transmission.

If no random access response is received within the random access response window, and/or if none of the received random access responses contains a random access preamble identifier corresponding to the transmitted random access preamble, the random access response reception may be considered unsuccessful and the wireless device may, based on the backoff parameter in the wireless device, select a random backoff time and delay the subsequent random access transmission by the backoff time, and may retransmit another random access preamble.

According to some of the various aspects of embodiments, a wireless device may transmit packets on an uplink carrier. Uplink packet transmission timing may be calculated in the wireless device using the timing of synchronization signal(s) received in a downlink. Upon reception of a timing alignment command by the wireless device, the wireless device may adjust its uplink transmission timing. The timing alignment command may indicate the change of the uplink timing relative to the current uplink timing. The uplink transmission timing for an uplink carrier may be determined using time alignment commands and/or downlink reference signals.

According to some of the various aspects of embodiments, a time alignment command may indicate timing adjustment for transmission of signals on uplink carriers. For example, a time alignment command may use 6 bits. Adjustment of the uplink timing by a positive or a negative amount indicates advancing or delaying the uplink transmission timing by a given amount respectively.

For a timing alignment command received on subframe n, the corresponding adjustment of the timing may be applied with some delay, for example, it may be applied from the beginning of subframe n+6. When the wireless device's uplink transmissions in subframe n and subframe n+1 are overlapped due to the timing adjustment, the wireless device may transmit complete subframe n and may not transmit the overlapped part of subframe n+1.

According to some of the various aspects of embodiments, a wireless device may include a configurable timer (timeAlignmentTimer) that may be used to control how long the wireless device is considered uplink time aligned. When a timing alignment command MAC control element is received, the wireless device may apply the timing alignment command and start or restart timeAlignmentTimer. The wireless device may not perform any uplink transmission except the random access preamble transmission when timeAlignmentTimer is not running or when it exceeds its limit. The time alignment command may substantially align frame and subframe reception timing of a first uplink carrier and at least one additional uplink carrier. According to some of the various aspects of embodiments, the time alignment command value range employed during a random access process may be substantially larger than the time alignment command value range during active data transmission. In an example embodiment, uplink transmission timing may be maintained on a per time alignment group (TAG) basis. Carrier(s) may be grouped in TAGs, and TAG(s) may have their own downlink timing reference, time alignment timer, and/or time alignment commands. Group(s) may have their own random access process. Time alignment commands may be directed to a time alignment group. The TAG, including the primary cell may be called a primary TAG (pTAG) and the TAG not including the primary cell may be called a secondary TAG (sTAG).

According to some of the various aspects of embodiments, control message(s) or control packet(s) may be scheduled for transmission in a physical downlink shared channel (PDSCH) and/or physical uplink shared channel PUSCH. PDSCH and PUSCH may carry control and data message(s)/packet(s). Control message(s) and/or packet(s) may be processed before transmission. For example, the control message(s) and/or packet(s) may be fragmented or multiplexed before transmission. A control message in an upper layer may be processed as a data packet in the MAC or physical layer. For example, system information block(s) as well as data traffic may be scheduled for transmission in PDSCH. Data packet(s) may be encrypted packets.

According to some of the various aspects of embodiments, data packet(s) may be encrypted before transmission to secure packet(s) from unwanted receiver(s). Desired recipient(s) may be able to decrypt the packet(s). A first plurality of data packet(s) and/or a second plurality of data packet(s) may be encrypted using an encryption key and at least one parameter that may change substantially rapidly over time. The encryption mechanism may provide a transmission that may not be easily eavesdropped by unwanted receivers. The encryption mechanism may include additional parameter(s) in an encryption module that changes substantially rapidly in time to enhance the security mechanism. Example varying parameter(s) may comprise various types of system counter(s), such as system frame number. Substantially rapidly may for example imply changing on a per subframe, frame, or group of subframes basis. Encryption may be provided by a PDCP layer between the transmitter and receiver, and/or may be provided by the application layer. Additional overhead added to packet(s) by lower layers such as RLC, MAC, and/or Physical layer may not be encrypted before transmission. In the receiver, the plurality of encrypted data packet(s) may be decrypted using a first decryption key and at least one first parameter. The plurality of data packet(s) may be decrypted using an additional parameter that changes substantially rapidly over time.

According to some of the various aspects of embodiments, a wireless device may be preconfigured with one or more carriers. When the wireless device is configured with more than one carrier, the base station and/or wireless device may activate and/or deactivate the configured carriers. One of the carriers (the primary carrier) may always be activated. Other carriers may be deactivated by default and/or may be activated by a base station when needed. A base station may activate and deactivate carriers by sending an activation/deactivation MAC control element. Furthermore, the UE may maintain a carrier deactivation timer per configured carrier and deactivate the associated carrier upon its expiry. The same initial timer value may apply to instance(s) of the carrier deactivation timer. The initial value of the timer may be configured by a network. The configured carriers (unless the primary carrier) may be initially deactivated upon addition and after a handover.

According to some of the various aspects of embodiments, if a wireless device receives an activation/deactivation MAC control element activating the carrier, the wireless device may activate the carrier, and/or may apply normal carrier operation including: sounding reference signal transmissions on the carrier, CQI (channel quality indicator)/PMI (precoding matrix indicator)/RI (ranking indicator) reporting for the carrier, PDCCH monitoring on the carrier, PDCCH monitoring for the carrier, start or restart the carrier deactivation timer associated with the carrier, and/or the like. If the device receives an activation/deactivation MAC control element deactivating the carrier, and/or if the carrier deactivation timer associated with the activated carrier expires, the base station or device may deactivate the carrier, and may stop the carrier deactivation timer associated with the carrier, and/or may flush HARQ buffers associated with the carrier.

If PDCCH on a carrier scheduling the activated carrier indicates an uplink grant or a downlink assignment for the activated carrier, the device may restart the carrier deactivation timer associated with the carrier. When a carrier is deactivated, the wireless device may not transmit SRS (sounding reference signal) for the carrier, may not report CQI/PMI/RI for the carrier, may not transmit on UL-SCH for the carrier, may not monitor the PDCCH on the carrier, and/or may not monitor the PDCCH for the carrier.

A process to assign subcarriers to data packets may be executed by a MAC layer scheduler. The decision on assigning subcarriers to a packet may be made based on data packet size, resources required for transmission of data packets (number of radio resource blocks), modulation and coding assigned to data packet(s), QoS required by the data packets (i.e. QoS parameters assigned to data packet bearer), the service class of a subscriber receiving the data packet, or subscriber device capability, a combination of the above, and/or the like.

According to some of the various aspects of embodiments, packets may be referred to service data units and/or protocols data units at Layer 1, Layer 2 and/or Layer 3 of the communications network. Layer 2 in an LTE network may include three sub-layers: PDCP sub-layer, RLC sub-layer, and MAC sub-layer. A layer 2 packet may be a PDCP packet, an RLC packet or a MAC layer packet. Layer 3 in an LTE network may be Internet Protocol (IP) layer, and a layer 3 packet may be an IP data packet. Packets may be transmitted and received via an air interface physical layer. A packet at the physical layer may be called a transport block. Many of the various embodiments may be implemented at one or many different communication network layers. For example, some of the actions may be executed by the PDCP layer and some others by the MAC layer.

According to some of the various aspects of embodiments, subcarriers and/or resource blocks may comprise a plurality of physical subcarriers and/or resource blocks. In another example embodiment, subcarriers may be a plurality of virtual and/or logical subcarriers and/or resource blocks.

According to some of the various aspects of embodiments, a radio bearer may be a GBR (guaranteed bit rate) bearer and/or a non-GBR bearer. A GBR and/or guaranteed bit rate bearer may be employed for transfer of real-time packets, and/or a non-GBR bearer may be used for transfer of non-real-time packets. The non-GBR bearer may be assigned a plurality of attributes including: a scheduling priority, an allocation and retention priority, a portable device aggregate maximum bit rate, and/or the like. These parameters may be used by the scheduler in scheduling non-GBR packets. GBR bearers may be assigned attributes such as delay, jitter, packet loss parameters, and/or the like.

According to some of the various aspects of embodiments, subcarriers may include data subcarrier symbols and pilot subcarrier symbols. Pilot symbols may not carry user data, and may be included in the transmission to help the receiver to perform synchronization, channel estimation and/or signal quality detection. Base stations and wireless devices (wireless receiver) may use different methods to generate and transmit pilot symbols along with information symbols.

According to some of the various aspects of embodiments, the transmitter in the disclosed embodiments of the present invention may be a wireless device (also called user equipment), a base station (also called eNodeB), a relay node transmitter, and/or the like. The receiver in the disclosed embodiments of the present invention may be a wireless device (also called user equipment-UE), a base station (also called eNodeB), a relay node receiver, and/or the like. According to some of the various aspects of embodiments of the present invention, layer 1 (physical layer) may be based on OFDMA or SC-FDMA. Time may be divided into frame(s) with fixed duration. Frame(s) may be divided into substantially equally sized subframes, and subframe(s) may be divided into substantially equally sized slot(s). A plurality of OFDM or SC-FDMA symbol(s) may be transmitted in slot(s). OFDMA or SC-FDMA symbol(s) may be grouped into resource block(s). A scheduler may assign resource(s) in resource block unit(s), and/or a group of resource block unit(s). Physical resource block(s) may be resources in the physical layer, and logical resource block(s) may be resource block(s) used by the MAC layer. Similar to virtual and physical subcarriers, resource block(s) may be mapped from logical to physical resource block(s). Logical resource block(s) may be contiguous, but corresponding physical resource block(s) may be non-contiguous. Some of the various embodiments of the present invention may be implemented at the physical or logical resource block level(s).

According to some of the various aspects of embodiments, layer 2 transmission may include PDCP (packet data convergence protocol), RLC (radio link control), MAC (media access control) sub-layers, and/or the like. MAC may be responsible for the multiplexing and mapping of logical channels to transport channels and vice versa. A MAC layer may perform channel mapping, scheduling, random access channel procedures, uplink timing maintenance, and/or the like.

According to some of the various aspects of embodiments, the MAC layer may map logical channel(s) carrying RLC PDUs (packet data unit) to transport channel(s). For transmission, multiple SDUs (service data unit) from logical channel(s) may be mapped to the Transport Block (TB) to be sent over transport channel(s). For reception, TBs from transport channel(s) may be demultiplexed and assigned to corresponding logical channel(s). The MAC layer may perform scheduling related function(s) in both the uplink and downlink and thus may be responsible for transport format selection associated with transport channel(s). This may include HARQ functionality. Since scheduling may be done at the base station, the MAC layer may be responsible for reporting scheduling related information such as UE (user equipment or wireless device) buffer occupancy and power headroom. It may also handle prioritization from both an inter-UE and intra-UE logical channel perspective. MAC may also be responsible for random access procedure(s) for the uplink that may be performed following either a contention and non-contention based process. UE may need to maintain timing synchronization with cell(s). The MAC layer may perform procedure(s) for periodic synchronization.

According to some of the various aspects of embodiments, the MAC layer may be responsible for the mapping of multiple logical channel(s) to transport channel(s) during transmission(s), and demultiplexing and mapping of transport channel data to logical channel(s) during reception. A MAC PDU may include of a header that describes the format of the PDU itself, which may include control element(s), SDUs, Padding, and/or the like. The header may be composed of multiple sub-headers, one for constituent part(s) of the MAC PDU. The MAC may also operate in a transparent mode, where no header may be pre-pended to the PDU. Activation command(s) may be inserted into packet(s) using a MAC control element.

According to some of the various aspects of embodiments, the MAC layer in some wireless device(s) may report buffer size(s) of either a single Logical Channel Group (LCG) or a group of LCGs to a base station. An LCG may be a group of logical channels identified by an LCG ID. The mapping of logical channel(s) to LCG may be set up during radio configuration. Buffer status report(s) may be used by a MAC scheduler to assign radio resources for packet transmission from wireless device(s). HARQ and ARQ processes may be used for packet retransmission to enhance the reliability of radio transmission and reduce the overall probability of packet loss.

According to some of the various aspects of embodiments, an RLC sub-layer may control the applicability and functionality of error correction, concatenation, segmentation, re-segmentation, duplicate detection, in-sequence delivery, and/or the like. Other functions of RLC may include protocol error detection and recovery, and/or SDU discard. The RLC sub-layer may receive data from upper layer radio bearer(s) (signaling and data) called service data unit(s) (SDU). The transmission entities in the RLC layer may convert RLC SDUs to RLC PDU after performing functions such as segmentation, concatenation, adding RLC header(s), and/or the like. In the other direction, receiving entities may receive RLC PDUs from the MAC layer. After performing reordering, the PDUs may be assembled back into RLC SDUs and delivered to the upper layer. RLC interaction with a MAC layer may include: a) data transfer for uplink and downlink through logical channel(s); b) MAC notifies RLC when a transmission opportunity becomes available, including the size of total number of RLC PDUs that may be transmitted in the current transmission opportunity, and/or c) the MAC entity at the transmitter may inform RLC at the transmitter of HARQ transmission failure.

According to some of the various aspects of embodiments, PDCP (packet data convergence protocol) may comprise a layer 2 sub-layer on top of RLC sub-layer. The PDCP may be responsible for a multitude of functions. First, the PDCP layer may transfer user plane and control plane data to and from upper layer(s). PDCP layer may receive SDUs from upper layer(s) and may send PDUs to the lower layer(s). In other direction, PDCP layer may receive PDUs from the lower layer(s) and may send SDUs to upper layer(s). Second, the PDCP may be responsible for security functions. It may apply ciphering (encryption) for user and control plane bearers, if configured. It may also perform integrity protection for control plane bearer(s), if configured. Third, the PDCP may perform header compression service(s) to improve the efficiency of over the air transmission. The header compression may be based on robust header compression (ROHC). ROHC may be performed on VOIP packets. Fourth, the PDCP may be responsible for in-order delivery of packet(s) and duplicate detection service(s) to upper layer(s) after handover(s). After handover, the source base station may transfer unacknowledged packet(s)s to target base station when operating in RLC acknowledged mode (AM). The target base station may forward packet(s)s received from the source base station to the UE (user equipment).

In this specification, “a” and “an” and similar phrases are to be interpreted as “at least one” and “one or more.” In this specification, the term “may” is to be interpreted as “may, for example,” In other words, the term “may” is indicative that the phrase following the term “may” is an example of one of a multitude of suitable possibilities that may, or may not, be employed to one or more of the various embodiments.

Many of the elements described in the disclosed embodiments may be implemented as modules. A module is defined here as an isolatable element that performs a defined function and has a defined interface to other elements. The modules described in this disclosure may be implemented in hardware, software in combination with hardware, firmware, wetware (i.e hardware with a biological element) or a combination thereof, all of which are behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or Lab VIEWMathScript. Additionally, it may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) using FDD communication systems. However, one skilled in the art will recognize that embodiments of the invention may also be implemented in TDD communication systems. The disclosed methods and systems may be implemented in wireless or wireline systems. The features of various embodiments presented in this invention may be combined. One or many features (method or system) of one embodiment may be implemented in other embodiments. Only a limited number of example combinations are shown to indicate to one skilled in the art the possibility of features that may be combined in various embodiments to create enhanced transmission and reception systems and methods.

In addition, it should be understood that any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A method comprising:
receiving, by a base station configured to communicate employing a plurality of downlink carriers and a plurality of uplink carriers, a first random access preamble:
from a wireless device operating in an RRC-Idle mode; and
on a first plurality of subcarriers on a first uplink carrier in said plurality of uplink carriers;
transmitting, by said base station, an RRC establishment message on a first data channel on a first downlink carrier in said plurality of downlink carriers, said RRC establishment message configured to cause establishment of a first signaling bearer, said first signaling bearer established on said first downlink carrier and said first uplink carrier; said first downlink carrier corresponding to said first uplink carrier;
establishing, by said base station, a security context with said wireless device employing said first signaling bearer;
transmitting, by said base station, an RRC reconfiguration message on said first data channel on said first downlink carrier, said RRC reconfiguration message directing said wireless device to connect to a second downlink carrier in said plurality of downlink carriers;
transmitting, by said base station, a plurality of data packets on said first downlink carrier and said second downlink carrier to said wireless device; and
receiving, by said base station, control data over a physical uplink control channel on said second uplink carrier, said control data comprising at least one of the following:
positive/negative acknowledgements for some of said plurality of data packets transmitted on said first downlink carrier and said second downlink carrier; and
channel state information for said first downlink carrier and said second downlink carrier; and
wherein said second uplink carrier corresponds to said second downlink carrier.

2. The method of claim 1, further comprising receiving a second random access preamble on a second plurality of subcarriers from said wireless device on said second uplink carrier:
a) after transmitting said RRC reconfiguration message; and
b) before transmitting said plurality of data packets.

3. The method of claim 1, wherein said wireless device does not employ a physical uplink control channel on said second uplink carrier before said RRC reconfiguration message is received.

4. The method of claim 1, wherein said wireless device does not employ a physical uplink control channel on said first uplink carrier:
a) after said RRC reconfiguration message is processed; and
b) before another RRC message is received by said wireless device.

5. The method of claim 1, further comprising transmitting, by said base station, a paging signal to said wireless device on said first downlink carrier before receiving said first random access preamble.

6. The method of claim 1, wherein said RRC reconfiguration message is transmitted, by said base station, when a traffic load of said first uplink carrier and said second uplink carrier are substantially different.

7. The method of claim 1, wherein said RRC reconfiguration message is transmitted when the traffic load of said first downlink carrier and said second downlink carrier are substantially different.

8. A method comprising:
transmitting, by a base station configured to communicate employing a plurality of downlink carriers and a plurality of uplink carriers, a first plurality of data packets on a first downlink carrier and a second downlink carrier to a wireless device, said first downlink carrier carrying the broadcast control information for said wireless device;
receiving, by said base station, first control data over a first physical uplink control channel on a first uplink carrier, said first uplink carrier corresponding to said first downlink carrier, said first control data comprising:
positive/negative acknowledgements for some of said first plurality of data packets transmitted on said first downlink carrier and said second downlink carrier; and
channel state information for said first downlink carrier and said second downlink carrier;
receiving, by said base station, at least one measurement report from said wireless device, said at least one measurement report comprising signal quality information of:
a first plurality of OFDM subcarriers of said first downlink carrier; and
a second plurality of OFDM subcarriers of said second downlink carrier;
transmitting, selectively, by said base station, at least one control message to said wireless device if said at least one measurement report satisfies a plurality of predefined criteria, said at least one control message reconfiguring the configuration of said first downlink carrier and said second downlink carrier of said wireless device;
transmitting, by said base station, a second plurality of data packets on said second downlink carrier to said wireless device; said second downlink carrier carrying the broadcast control information for said wireless device; and
receiving, by said base station, second control data of a second physical uplink control channel on a second uplink carrier, said second uplink carrier corresponding to said second downlink carrier, said second control data comprising:
positive/negative acknowledgements for some of said second plurality of data packets on said second downlink carrier; and
channel state information for said second downlink carrier.

9. The method of claim 8, wherein said plurality of predefined criteria comprises satisfying a condition in which said signal quality of said second downlink carrier is above said signal quality of said first downlink carrier by a threshold margin.

10. The method of claim 8, further comprising transmitting, by said base station, a paging signal to said wireless device on said first downlink carrier before receiving said first random access preamble.

11. The method of claim 8, further comprising receiving, by said base station, a first random access preamble:
a) before transmitting said first plurality of data packets;
b) from said wireless device operating in an RRC-Idle mode; and
c) on a first plurality of subcarriers on said first uplink carrier in said plurality of uplink carriers.

12. A wireless device comprising:
one or more communication interfaces configured to communicate employing a plurality of downlink carriers and a plurality of uplink carriers;
one or more processors; and
memory storing instructions that, when executed, cause said wireless device to:
receive a first plurality of data packets on a first downlink carrier and a second downlink carrier from a base station, said first downlink carrier carrying broadcast control information for said wireless device;
transmit first control data over a first physical uplink control channel on a first uplink carrier, said first uplink carrier corresponding to said first downlink carrier, said first control data comprising:
positive/negative acknowledgements for some of said first plurality of data packets received on said first downlink carrier and said second downlink carrier; and
channel state information for said first downlink carrier and said second downlink carrier;
receive at least one control message from said base station, said control message causes reconfiguration of said first downlink carrier and said second downlink carrier of said wireless device;
receive a second plurality of data packets on said first downlink carrier and said second downlink carrier from said base station, said second downlink carrier carrying broadcast control information for said wireless device; and
transmit second control data over a second physical uplink control channel on a second uplink carrier, said second uplink carrier corresponds to said second downlink carrier, said second control data comprising:
positive/negative acknowledgements for some of said second plurality of data packets on said second downlink carrier; and
channel state information for said first downlink carrier and said second downlink carrier.

13. The wireless device of claim 12, wherein said control message is received when:
a) a load of said first uplink carrier and said second uplink carrier are substantially different; or
b) a load of said first downlink carrier and said second downlink carrier are substantially different.

14. The wireless device of claim 13, wherein said load is the load of an uplink control channel.

15. The wireless device of claim 13, wherein said load is the number of wireless devices with a given downlink carrier as their primary carrier.

16. The wireless device of claim 13, wherein said load is the load of a downlink control channel.

17. The wireless device of claim 12, wherein said control message is received by said wireless device if a signal quality of said second downlink carrier is above said signal quality of said first downlink carrier by a threshold margin.

18. The wireless device of claim 12, further comprising instructions configured to cause said wireless device to receive a paging signal from said base station on said first downlink carrier before transmitting said first random access preamble.

19. The wireless device of claim 12, further comprising instructions configured to cause said wireless device to transmit a first random access preamble on a first plurality of subcarriers on said first uplink carrier before receiving said first plurality of data packets.

20. The method of claim 12, wherein said wireless device does not employ a physical uplink control channel on said first uplink carrier after said control message is processed and before an RRC message is received by said wireless device.
